(19) United States
(12) Patent Application Publication
(10) Pub. No.: US 2022/0072606 A1
(43) Pub. Date: Mar. 10, 2022

(54) PRESSED POWDER MATERIAL AND ROTATING ELECTRIC MACHINE

(71) Applicant: KABUSHIKI KAISHA TOSHIBA, Tokyo (JP)

(72) Inventors: Tomohiro SUETSUNA, Kawasaki Kanagawa (JP); Hiroaki KINOUCHI, Meguro Tokyo (JP); Naoyuki SANADA, Kawasaki Kanagawa (JP); Masaya HAGIWARA, Yokohama Kanagawa (JP)

(73) Assignee: KABUSHIKI KAISHA TOSHIBA, Tokyo (JP)

(21) Appl. No.: 17/249,599

(22) Filed: Mar. 5, 2021

(30) Foreign Application Priority Data
Sep. 4, 2020 (JP) 2020-148734

(51) Int. Cl. B22F 1/00; H02K 1/02; C22C 38/10; C22C 38/02

(52) U.S. Cl. CPC B22F 1/0055; H02K 1/02; B22F 2301/35; C22C 38/02; C22C 2202/02; C22C 38/10

(57) ABSTRACT

A pressed powder material of embodiments is a pressed powder material including a plurality of flaky magnetic metal particles and an intercalated phase, each of the flaky magnetic metal particles having a flat surface and a magnetic metal phase containing at least one first element selected from the group consisting of Fe, Co, and Ni, the flaky magnetic metal particles having an average thickness of from 10 nm to 100 μm and an average value of the ratio of the average length in the flat surface with respect to the thickness of from 5 to 10,000, the intercalated phase existing between the flaky magnetic metal particles and containing at least one second element selected from the group consisting of oxygen (O), carbon (C), nitrogen (N), and fluorine (F), wherein in the pressed powder material, the flat surface is oriented in parallel to a plane of the pressed powder material and has the difference in coercivity on the basis of direction within the plane, the intercalated phase includes an oxide and a resin, the softening temperature of the oxide is higher than the softening temperature of the resin, and the oxide is fixed to at least a portion of the flaky magnetic metal particles.

### CROSS-REFERENCE TO RELATED APPLICATION

This application is based upon and claims the benefit of priority from Japanese Patent Application No. 2020-148734, filed on Sep. 4, 2020, the entire contents of which are incorporated herein by reference.

### FIELD

Embodiments described herein relate generally to a pressed powder material and a rotating electric machine.

### BACKGROUND

Currently, soft magnetic materials are applied to the component parts of various systems and devices, such as rotating electric machines (for example, motors and generators), potential transformers, inductors, transformers, magnetic inks, and antenna devices. Thus, soft magnetic materials are regarded as very important materials. In these component parts, the real part of the magnetic permeability (real part of the relative magnetic permeability), μ′, of a soft magnetic material is utilized, and therefore, in the case of actual use, it is preferable to control μ′ in accordance with the working frequency band. Furthermore, in order to realize a highly efficient system, it is preferable to use a material having a loss that is as low as possible. That is, it is preferable to make the imaginary part of the magnetic permeability (imaginary part of the relative magnetic permeability), μ″ (corresponding to a loss), as low as possible. In regard to the loss, the loss factor, tan δ (=μ″/μ′×100(%)) serves as a criterion, and as μ″ becomes smaller relative to μ′, the loss factor tan δ becomes smaller, which is preferable. In order to attain such conditions, it is preferable to make the core loss for the conditions of actual operation small, that is, it is preferable to make the eddy current loss, hysteresis loss, ferromagnetic resonance loss, and residual loss (other losses) as small as possible. In order to make the eddy current loss small, it is effective to increase the electrical resistance, decrease the sizes of metal parts, or finely divide the magnetic domain structure. In order to make the hysteresis loss small, it is effective to reduce coercivity or increase the saturation magnetization. In order to make the ferromagnetic resonance loss small, it is effective to make the ferromagnetic resonance frequency higher by increasing the anisotropic magnetic field of the material. Furthermore, in recent years, since there is an increasing demand for handling of high electric power, it is required that losses are small, particularly under the operation conditions in which the effective magnetic field applied to the material is large, such as high current and high voltage. To attain this end, it is preferable that the saturation magnetization of a soft magnetic material is as large as possible so as not to bring about magnetic saturation. Furthermore, in recent years, since size reduction of equipment is enabled by utilization of high frequency, increase of the working frequency bands in systems and device equipment is underway, and there is an urgent need for the development of a magnetic material having high magnetic permeability and low losses at high frequency and having excellent characteristics.

Furthermore, in recent years, due to the heightened awareness of the issues on energy saving and environmental issues, there is a demand to increase the efficiency of systems as high as possible. Particularly, since motor systems are responsible for a major portion of electric power consumption in the world, efficiency enhancement of motors is very important. Above all, a core and the like that constitute a motor are formed from soft magnetic materials, and it is requested to increase the magnetic permeability or saturation magnetization of soft magnetic materials as high as possible, or to make the losses as low as possible. Furthermore, in regard to magnetic wedges that are used in some motors, there is a demand for minimizing losses as far as possible. There is the same demand also for systems that use transformers. In motors, transformers and the like, the demand for size reduction is also high, along with efficiency enhancement. In order to realize size reduction, it is essential to maximize the magnetic permeability and saturation magnetization of the soft magnetic materials as far as possible. Furthermore, in order to also prevent magnetic saturation, it is important to make saturation magnetization as high as possible. Moreover, the need for increasing the operation frequency of systems is also high, and thus, there is a demand to develop a material having low losses in high frequency bands.

Soft magnetic materials having high magnetic permeability and low losses are also used in inductance elements, antenna devices and the like, and particularly above all, in recent years, attention has been paid to the application of soft magnetic materials in power inductance elements that are used in power semiconductor devices. In recent years, the importance of energy saving and environmental protection has been actively advocated, and reduction of the amount of CO₂ emission and reduction of the dependency on fossil fuels have been required. As the result, development of electric cars or hybrid cars that substitute gasoline cars is in active progress. Furthermore, technologies for utilizing natural energy such as solar power generation and wind power generation are regarded as key technologies for an energy saving society, and many developed countries are actively pushing ahead with the development of technologies for utilizing natural energy. Furthermore, the importance of establishment of home energy management system (HEMS) and building and energy management system (BEMS), which control the electric power generated by solar power generation, wind power generation or the like by a smart grid and supply the electric power to homes, offices and plants with high efficiency, as environment-friendly power saving systems, has been actively advocated. In such a movement of energy saving, power semiconductor devices play a key role. Power semiconductor devices are semiconductor devices that control high electric power or energy with high efficiency, and examples thereof include individual power semiconductor devices such as an insulated gate bipolar transistor (IGBT), a metal oxide semiconductor field effect transistor (MOSFET), a power bipolar transistor, and a power diode; power supply circuits such as a linear regulator and a switching regulator; and a large-scale integration (LSI) logic circuit for power management to control the above-mentioned devices. Power semiconductor devices are widely used in all sorts of equipment including home electrical appliances, computers, automobiles and railways, and since expansion of the supply of these applied apparatuses, and an increase in the mounting ratio of power semiconductor devices in these apparatuses can be expected, a rapid growth in the market for power semiconductor devices in the future is anticipated. For example, inverters that are installed in many home electrical appliances use power semiconductor devices nearly in all parts, and thereby extensive energy saving is made possible. Currently, silicon (Si) occupies a major part in power semiconductor devices; however, for a further increase in efficiency or further size reduction of equipment, utilizing silicon carbide (SiC) and gallium nitride (GaN) is considered effective. Since SiC and GaN have larger band gaps and larger breakdown fields than Si, and the breakdown voltage can be made higher, elements can be made thinner. Therefore, the on-resistance of semiconductor devices can be lowered, and it is effective for loss reduction and efficiency enhancement. Furthermore, since SiC or GaN has high carrier mobility, the switching frequency can be made higher, and this is effective for size reduction of elements. Furthermore, since SiC in particular has higher thermal conductivity than Si, the heat dissipation ability is higher, and operation at high temperature is enabled. Thus, cooling systems can be simplified, and this is effective for size reduction. From the viewpoints described above, development of SiC and GaN power semiconductor devices is actively in progress. However, in order to realize the development, development of power inductor elements that are used together with power semiconductor devices, that is, development of soft magnetic materials having high magnetic permeability (high magnetic permeability and low losses), is indispensable. Regarding the characteristics required for magnetic materials in this case, high magnetic permeability and low magnetic loss in the driving frequency bands, as well as high saturation magnetization that can cope with a large electric current are preferable. In a case in which saturation magnetization is high, it is difficult to induce magnetic saturation even if a high magnetic field is applied, and a decrease in the effective inductance value can be suppressed. As a result, the direct current superimposition characteristics of the device are enhanced, and the efficiency of the system is increased.

Furthermore, a magnetic material having high magnetic permeability and low losses at high frequency is expected to be applied to the devices of high frequency communication equipment such as antenna devices. As a method for achieving size reduction and power saving of antennas, there is a method of using an insulated substrate having high magnetic permeability (high magnetic permeability and low losses) as an antenna substrate, and performing transmission and reception of electric waves by dragging the electric waves that should reach an electronic component or a substrate inside communication equipment from antennas into the antenna substrate, without allowing the electric waves to reach the electronic component or substrate. As a result, size reduction of antennas and power saving are made possible, and at the same time, the resonance frequency band of the antennas can also be broadened, which is preferable.

Furthermore, examples of other characteristics that are required when magnetic materials are incorporated into the various systems and devices described above include high thermal stability, high strength, and high toughness. Also, in order for the magnetic materials to be applied to complex shapes, a pressed powder body is more preferable than materials having a sheet shape or a ribbon shape. However, generally, when a pressed powder body is used, it is known that characteristics such as saturation magnetization, magnetic permeability, losses, strength, and toughness are deteriorated. Thus, enhancement of characteristics is preferable.

Next, in regard to existing soft magnetic materials, the types of the soft magnetic materials and their problems will be described.

Examples of an existing soft magnetic material for systems of 10 kH or less include a silicon steel sheet (FeSi). A silicon steel sheet is a material that is employed in most of rotating electric machines that have been used for a long time and handle large power, and the core materials of transformers. Characteristics enhancement from non-directional silicon steel sheets to directional silicon steel sheets can be attempted, and compared to the early stage of discovery, a progress has been made; however, in recent years, it is considered that characteristics improvement has reached an endpoint. Regarding the characteristics, it is particularly critical to simultaneously satisfy high saturation magnetization, high magnetic permeability, and low losses. Studies on materials that surpass silicon steel sheets are actively conducted globally, mainly based on the compositions of amorphous materials and nanocrystalline materials; however, a material composition that surpasses silicon steel sheets in all aspects has not yet been found. Furthermore, studies also have been conducted on pressed powder bodies that are applicable to complex shapes; however, pressed powder bodies have a defect that they have poor characteristics compared to sheets or ribbons.

Examples of existing soft magnetic materials for systems of 10 kHz to 100 kHz include Sendust (Fe—Si—Al), nanocrystalline FINEMET (Fe—Si—B—Cu—Nb), ribbons or pressed powder bodies of Fe-based or Co-based amorphous glass, or MnZn-based ferrite materials. However, all of these materials do not completely satisfy characteristics such as high magnetic permeability, low losses, high saturation magnetization, high thermal stability, high strength, and high toughness, and the materials are insufficient.

Examples of existing soft magnetic materials of 100 kHz or higher (MHz frequency band or higher) include NiZn-based ferrites and hexagonal ferrites; however, these materials have insufficient magnetic characteristics at high frequency.

From the circumstances described above, development of a magnetic material having high saturation magnetization, high magnetic permeability, low losses, high thermal stability, and excellent mechanical characteristics is preferable.

### BRIEF DESCRIPTION OF THE DRAWINGS

FIG. 1 is a conceptual diagram illustrating an example of a method for determining the thickness of a flaky magnetic metal particle in a pressed powder material according to a first embodiment;

FIGS. 2A to 2C are conceptual diagrams for describing a method for determining the maximum length and the minimum length in a flat surface of a flaky magnetic metal particle in the pressed powder material according to the first embodiment;

FIG. 3 is a conceptual diagram for describing another example of the method for determining the maximum length and the minimum length in a flat surface of a flaky magnetic metal particle in the pressed powder material according to the first embodiment;

FIG. 4 is a schematic diagram illustrating the directions used when the coercivity is measured by varying the direction at an interval of 22.5° over an angle range of 360° in a flat surface of a flaky magnetic metal particle in the pressed powder material according to the first embodiment;

FIG. 5 is a schematic perspective view of the flaky magnetic metal particles in the pressed powder material according to the first embodiment;

FIG. 6 is a schematic diagram of a flaky magnetic metal particle in the pressed powder material according to the first embodiment as viewed from above;

FIGS. 7A and 7B are schematic diagrams of flaky magnetic metal particles in the pressed powder material according to the first embodiment;

FIG. 8 is a schematic diagram of the pressed powder material according to the first embodiment;

FIG. 9 is a schematic diagram illustrating the angle formed by a face parallel to the flat surface of a flaky magnetic metal particle and a plane of the pressed powder material, in the pressed powder material according to the first embodiment;

FIG. 10 is an example of scanning electron microscopic photograph of the pressed powder material according to the first embodiment;

FIG. 11 is an example of a specific effect in the case of adding a resin and an oxide to the pressed powder material according to the first embodiment under particular conditions;

FIG. 12 is a conceptual diagram of a motor system according to a second embodiment;

FIG. 13 is a conceptual diagram of a motor according to the second embodiment;

FIG. 14 is a conceptual diagram of a motor core (stator) according to the second embodiment;

FIG. 15 is a conceptual diagram of a motor core (rotor) according to the second embodiment;

FIG. 16 is a conceptual diagram of a potential transformer or a transformer according to the second embodiment;

FIG. 17 is a conceptual diagram of inductors (ring-shaped inductor and rod-shaped inductor) according to the second embodiment;

FIG. 18 is a conceptual diagram of inductors (chip inductor and planar inductor) according to the second embodiment;

FIG. 19 is a conceptual diagram of a generator according to the second embodiment; and

FIG. 20 is a conceptual diagram illustrating the relationship between the direction of the magnetic flux and the direction of disposition of a pressed powder material.

### DETAILED DESCRIPTION

In the following description, embodiments will be described using the attached drawings. In the diagrams, an identical or similar reference numeral will be assigned to identical or similar sites.

### First Embodiment

A pressed powder material according to the present embodiment is a pressed powder material including a plurality of flaky magnetic metal particles and an intercalated phase, and the flaky magnetic metal particles has an average thickness of from 10 nm to 100 μm, each of the flaky magnetic metal particles having a flat surface and a magnetic metal phase containing at least one first element selected from the group consisting of iron (Fe), cobalt (Co), and nickel (Ni), with the average value of the ratio of the average length in the flat surface with respect to the thickness being from 5 to 10,000, while the intercalated phase exists between the flaky magnetic metal particles and contains at least one second element selected from the group consisting of oxygen (O), carbon (C), nitrogen (N), and fluorine (F), wherein in the pressed powder material, the flat surface is oriented in parallel to a plane of the pressed powder material and has the difference in coercivity on the basis of direction within the plane, the intercalated phase includes an oxide and a resin, the softening temperature of the oxide is higher than the softening temperature of the resin, and the oxide is fixed to at least a portion of the flaky magnetic metal particles.

Flaky magnetic metal particles are flaky particles (or flattened particles) having a flaky shape (or a flattened shape).

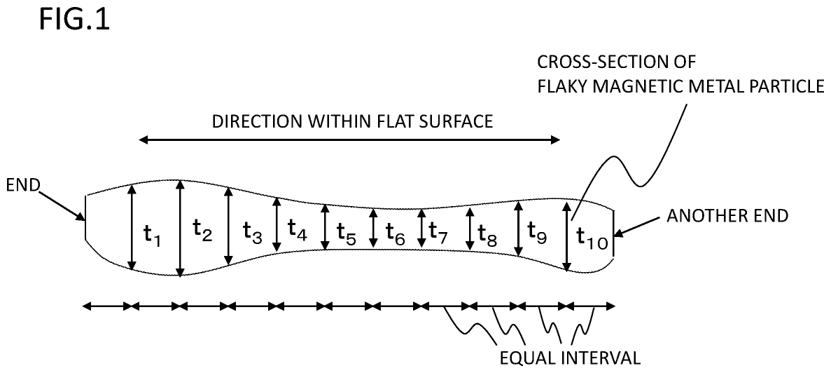

A thickness means an average thickness of a single flaky magnetic metal particle. Regarding the method for determining the thickness, the method is not limited as long as it is a method capable of determining the average thickness in one flaky magnetic metal particle. For example, a method of observing a cross-section that is perpendicular to a flat surface of a flaky magnetic metal particle by transmission electron microscopy (TEM), scanning electron microscopy (SEM), optical microscopy, or the like, selecting any arbitrary ten or more sites in the in-plane direction within the flat surface in a cross-section of the flaky magnetic metal particle thus observed, measuring the thicknesses at the various selected sites, and employing the average value of the thicknesses, may be used. Furthermore, a method of selecting ten or more sites in the observed cross-section of the flaky magnetic metal particle from an end toward the other end at an equal interval in an in-plane direction within the flat surface (at this time, since the end and the other end are special places, it is preferable not to select the end parts), measuring the thickness at each of the sites thus selected, and employing the average value of the thicknesses, may also be used. FIG. 1 is a conceptual diagram illustrating an example of a method for determining the thickness of a flaky magnetic metal particle in the pressed powder material according to the first embodiment. In FIG. 1, the method for determining the thickness in this case is specifically illustrated. All of the methods are preferable because when measurement is made at sites as many as possible, average information can be obtained. Meanwhile, in a case in which the contour lines of the cross-section has intense irregularities, or the surface has a rough contour line, and it is difficult to determine the average thickness in an intact state, it is preferable that the contour line is smoothened into an average straight line or curve appropriately according to the circumstance, and then the above-described method is carried out.

Furthermore, the average thickness refers to the average value of the thickness of a plurality of flaky magnetic metal particles, and the average thickness is distinguished from the simple “thickness” described above. When the average thickness is to be determined, it is preferable to employ an average value calculated for twenty or more flaky magnetic metal particles. Furthermore, it is preferable to determine the average thickness for as many flaky magnetic metal particles as possible as the objects of measurement, because average information can be obtained. Furthermore, in a case in which an observation of twenty or more flaky magnetic metal particles cannot be made, it is preferable that an observation of as many flaky magnetic metal particles as possible is made, and an average value calculated for those particles is employed. The average thickness of the flaky magnetic metal particles is preferably from 10 nm to 100 μm, more preferably from 10 nm to 1 μm, and even more preferably from 10 nm to 100 nm. Furthermore, it is preferable that the flaky magnetic metal particles include particles having a thickness of from 10 nm to 100 μm, more preferably from 10 nm to 1 μm, and even more preferably from 10 nm to 100 nm. As a result, when a magnetic field is applied in a direction parallel to the flat surface, the eddy current loss can be made sufficiently small, which is preferable. Furthermore, a smaller thickness is preferred because the magnetic moment is confined in a direction parallel to the flat surface, and magnetization is likely to proceed by rotation magnetization. In a case in which magnetization proceeds by rotation magnetization, since magnetization is likely to proceed reversibly, coercivity becomes small, and the hysteresis loss can be reduced thereby, which is preferable.

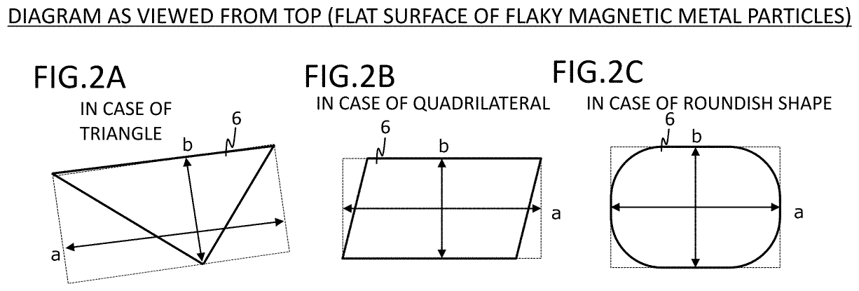

The average length of a flaky magnetic metal particle is defined by the formula: (a+b)/2, using the maximum length a and the minimum length b in the flat surface. The maximum length a and the minimum length b can be determined as follows. For example, among rectangles that circumscribe the flat surface, a rectangle having the smallest area is considered. Then, the length of the long side of the rectangle is designated as maximum length a, and the length of the short side is designated as minimum length b. FIGS. 2A to 2C are conceptual diagrams for describing a method for determining the maximum length and the minimum length in the flat surface of a flaky magnetic metal particle in the pressed powder material according to the first embodiment. FIGS. 2A to 2C are schematic diagrams illustrating the maximum length a and the minimum length b determined by the above-described method by taking several flaky magnetic metal particles as examples. The maximum length a and the minimum length b can be determined, similarly to the case of the average thickness, by observing the flaky magnetic metal particles by TEM, SEM, optical microscopy, or the like. Furthermore, it is also possible to determine the maximum length a and the minimum length b by performing an image analysis of microscopic photographs with a computer. For all of them, it is preferable to determine the maximum length and the minimum length for twenty or more flaky magnetic metal particles as the objects of measurement. Furthermore, it is preferable to determine the maximum length and the minimum length for as many flaky magnetic metal particles as possible as the objects of measurement because average information can be obtained. Furthermore, in a case in which it is not possible to observe twenty or more flaky magnetic metal particles, it is preferable that an observation of as many flaky magnetic metal particles as possible is made, and average values obtained for those metal particles are employed. Furthermore, in this case, since it is preferable to determine the maximum length and the minimum length as average values as far as possible, it is preferable to perform an observation or an image analysis in a state in which the flaky magnetic metal particles are uniformly dispersed (in a state in which a plurality of flaky magnetic metal particles having different maximum lengths and minimum lengths is dispersed in a manner as random as possible). For example, it is preferable that an observation or an image analysis is carried out by sufficiently stirring a plurality of flaky magnetic metal particles and adhering the flaky magnetic metal particles onto a tape in that stirred state, or by dropping a plurality of flaky magnetic metal particles from above to fall down and adhering the particles onto a tape.

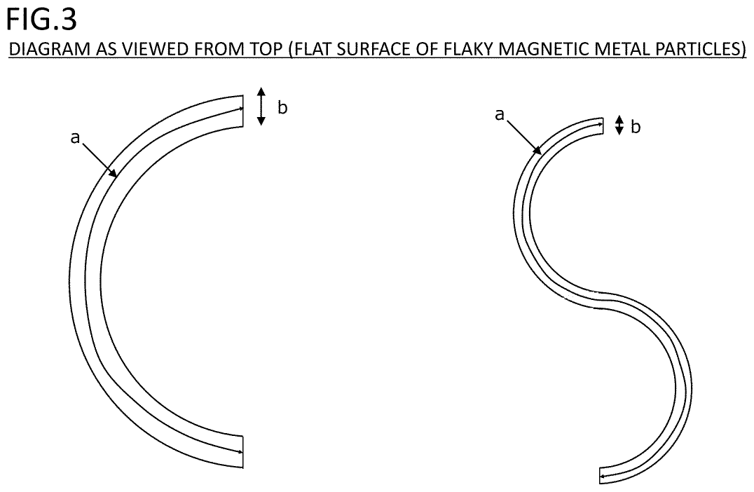

However, depending on the flaky magnetic metal particles, there are occasions in which when the maximum length a and the minimum length b are determined by the method described above, the method may become a determination method that does not have any regard to the essence. FIG. 3 is a conceptual diagram for describing another example of the method for determining the maximum length and the minimum length in a flat surface of a flaky magnetic metal particle in the pressed powder material according to the first embodiment. For example, in a case similar to FIG. 3, the flaky magnetic metal particles are in a state of being elongatedly curved state; however, in this case, the maximum length and the minimum length of the flaky magnetic metal particles are essentially the lengths of a and b illustrated in FIGS. 2A to 2C. As such, the method for determining the maximum length a and the minimum length b cannot be decided completely uniformly, and basically, there is no problem with a method of “considering a rectangle having the smallest area among the rectangles circumscribing the flat surface, and designating the length of the long side of the rectangle as the maximum length a, and the length of the short side as the minimum length b”. However, depending on the shape of the particles, in a case in which the essence is disregarded in this method, the maximum length a and the minimum length b are determined as the maximum length a and the minimum length b, for which the essence is considered, according to the circumstances. The thickness t is defined as the length in a direction perpendicular to the flat surface. The ratio A of the average length within the flat surface with respect to the thickness is defined by the formula: A=((a+b)/2)/t, using the maximum length a, minimum length b, and thickness t.

The average value of the ratio of the average length in the flat surface to the thickness of the flaky magnetic metal particles is preferably from 5 to 10,000. This is because the magnetic permeability increases according to the ratio. Furthermore, it is because since the ferromagnetic resonance frequency can be increased, the ferromagnetic resonance loss can be reduced.

Regarding the ratio of the average length in the flat surface with respect to the thickness, an average value is employed. Preferably, it is preferable to employ an average value calculated for twenty or more flaky magnetic metal particles. It is also preferable to determine the average value by taking as many flaky magnetic metal particles as possible as the objects of measurement, because average information can be obtained. In a case in which an observation of twenty or more flaky magnetic metal particles cannot be made, it is preferable that an observation is made for as many flaky magnetic metal particles as possible, and an average value calculated for those particles is employed. In addition, for example, in a case in which there are particle Pa, particle Pb, and particle Pc, and the thicknesses of the particles are referred to as Ta, Tb, and Tc, respectively, while the average lengths in the flat surface are referred to as La, Lb, and Lc, respectively, the average thickness is calculated by the formula: (Ta+Tb+Tc)/3, and the average value of the ratio of the average length in the flat surface with respect to the thickness is calculated by the formula: (La/Ta+Lb/Tb+Lc/Tc)/3.

It is preferable that the flaky magnetic metal particles have the difference in coercivity on the basis of direction within the flat surface. It is more preferable as the proportion of the difference in coercivity on the basis of direction is larger, and it is preferable that the proportion is 1% or more. More preferably, the proportion of the difference in coercivity is 10% or more; even more preferably, the proportion of the difference in coercivity is 50% or more; and still more preferably, the proportion of the difference in coercivity is 100% or more. The proportion of the difference in coercivity as used herein is defined by the formula: (Hc(max)−Hc(min))/Hc(min)×100(%), using the maximum coercivity Hc(max) and the minimum coercivity Hc(min) within the flat surface. Meanwhile, the coercivity can be evaluated using a vibrating sample magnetometer (VSM) or the like. In the case of having low coercivity, even a coercivity of 0.1 Oe or less can be measured by using a low magnetic field unit. In regard to the direction of the magnetic field to be measured, measurement is made by varying the direction within the flat surface.

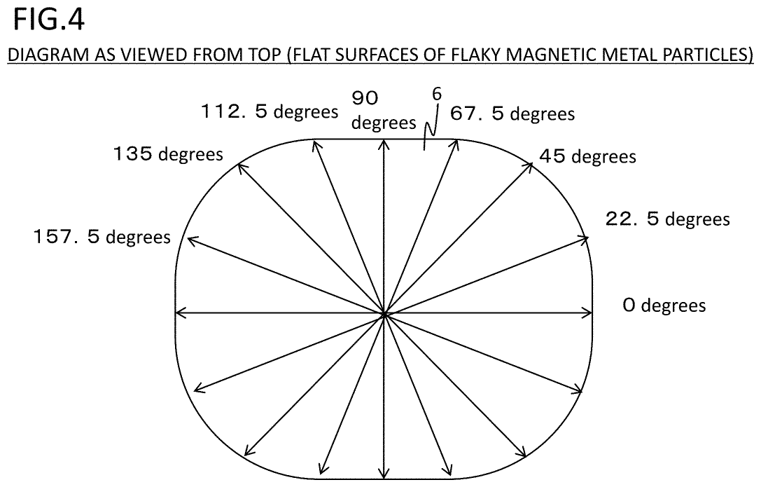

Meanwhile, the phrase “having the difference in coercivity” implies that when a magnetic field is applied in the direction of 360° in the flat surface and the coercivity is measured, there exist a direction in which maximum coercivity is obtained, and a direction in which minimum coercivity is obtained. For example, when the coercivity is measured by varying the direction at an interval of 22.5° over an angle range of 360° in the flat surface, in a case in which the difference in coercivity is exhibited, that is, there are an angle at which the coercivity becomes larger and an angle at which the coercivity becomes smaller, the concept of “having the difference in coercivity” applies. FIG. 4 is a schematic diagram illustrating the directions used when the coercivity is measured by varying the direction at an interval of 22.5° over an angle range of 360° in the flat surface of a flaky magnetic metal particle in the pressed powder material according to the first embodiment. By having the difference in coercivity within the flat surface, the minimum coercivity value becomes smaller compared to the case of isotropy with almost no difference in coercivity, which is preferable. In regard to a material exhibiting magnetic anisotropy within the flat surface, there is the difference in coercivity on the basis of direction within the flat surface, and the minimum coercivity value becomes small compared to a magnetically isotropic material. As a result, the hysteresis loss is reduced, and the magnetic permeability is increased, which is preferable.

Coercivity may be discussed using the approximation formula: Hc=αHa−NMs (Hc: coercivity, Ha: magnetocrystalline anisotropy, Ms: saturation magnetization, α, N: values that vary depending on the composition, texture, shape, or the like) in connection with magnetocrystalline anisotropy. That is, generally, there is a tendency that when the magnetocrystalline anisotropy increases, coercivity is likely to increase, whereas when the magnetocrystalline anisotropy decreases, coercivity is likely to decrease. However, the α value and the N value in the approximation formula are values that vary significantly depending on the composition, texture, or shape of the material, and even if the magnetocrystalline anisotropy is high, the coercivity may have a relatively small value (in a case in which the α value is small or the N value is large), or even if the magnetocrystalline anisotropy is small (in a case in which the α value is large or the N value is small), the coercivity may have a relatively large value. That is, magnetocrystalline anisotropy is a characteristic intrinsic to a substance, which is defined by the composition of the material; however, coercivity is a characteristic that is not defined only by the composition of the material but can greatly vary depending on the texture, shape, or the like. Furthermore, the magnetocrystalline anisotropy is not a factor that directly affects the hysteresis loss but is a factor that indirectly affects the hysteresis loss; however, coercivity is a factor that directly affects the loop area of a direct current magnetization curve (this area corresponds to the magnitude of the hysteresis loss). Therefore, coercivity is a factor that almost directly determines the magnitude of the hysteresis loss. That is, it can be said that unlike the magnetocrystalline anisotropy, coercivity is a very important factor that affects the hysteresis loss directly and significantly.

Furthermore, even when a flaky magnetic metal particle exhibits magnetic anisotropy including magnetocrystalline anisotropy, it cannot be necessarily said that the difference in coercivity is exhibited depending on the direction of the flat surface of the flaky magnetic metal particle. As described above, it is because coercivity is not α value that is decided uniformly by the magnetocrystalline anisotropy but is a characteristic that varies anyhow depending on the composition, texture, or shape of the material. Also, as described above, the factor that affects the hysteresis loss directly and significantly is not the magnetic anisotropy but is rather coercivity. Thus, a condition that is highly preferable toward characteristics improvement is “having the difference in coercivity on the basis of direction within the flat surface”. Thereby, the hysteresis loss is reduced, and the magnetic permeability is also increased, which is preferable.

The ratio of the maximum length a with respect to the minimum length b in the flat surface is preferably 2 or greater on the average, more preferably 3 or greater, even more preferably 5 or greater, and still more preferably 10 or greater. It is preferable that the ratio of the maximum length a with respect to the minimum length b in the flat surface include a ratio value of 2 or greater, more preferably a ratio value of 3 or greater, even more preferably a ratio value of 5 or greater, and still more preferably a ratio value of 10 or greater. Thereby, magnetic anisotropy can be induced easily, which is desirable. When magnetic anisotropy is induced, the difference in coercivity emerges within the flat surface, and the minimum coercivity value becomes smaller compared to magnetically isotropic materials. Thereby, the hysteresis loss is reduced, and the magnetic permeability is enhanced, which is preferable. More preferably, in regard to the flaky magnetic metal particles, it is desirable that either or both of a plurality of concavities and a plurality of convexities described below have their first directions arranged in the maximum length direction. In a case in which the flaky magnetic metal particles are powder-compacted, since the ratio of a to b of the flaky magnetic metal particles is large, the area (or area proportion) in which the flat surfaces of individual flaky magnetic metal particles overlap with one another becomes large, and the strength of the pressed powder body increases, which is preferable. Furthermore, when the ratio of the maximum length to the minimum length is larger, the magnetic moment is confined in a direction parallel to the flat surface, and magnetization is likely to proceed by rotation magnetization, which is preferable. In a case in which magnetization proceeds by rotation magnetization, since magnetization is likely to proceed reversibly, coercivity becomes small, and the hysteresis loss can be reduced thereby, which is preferable. On the other hand, from the viewpoint of improving the strength, it is preferable that the ratio of the maximum length a to the minimum length b in the flat surface is, on the average, 1 or higher and lower than 2, and more preferably, 1 or higher and lower than 1.5. Thereby, fluidity or the packing property of the particles is enhanced, which is desirable. Furthermore, the strength in a direction perpendicular to the flat surface is increased compared to the case of having a large value of the ratio of a to b, and it is preferable from the viewpoint of improving the strength of the flaky magnetic metal particles. Furthermore, when the particles are powder-compacted, there is less chance that the particles are powder-compacted in a bent state, and the stress to the particles is likely to be reduced. That is, strain is reduced, and this leads to reduction of the coercivity and the hysteresis loss. Also, since stress is reduced, thermal stability and mechanical characteristics such as strength and toughness are likely to be enhanced.

Furthermore, a particle having a corner in at least a portion of the contour shape of the flat surface is preferably used. For example, a contour shape such as a square or a rectangle, in other words, a contour shape having an angle of a corner of approximately 90°, is desirable. As a result, symmetry of the atomic arrangement is decreased at the corner parts, the electron orbits are confined, and therefore, magnetic anisotropy can be easily induced to the flat surface, which is desirable.

On the other hand, from the viewpoint of loss reduction or strength improvement, it is desirable that the contour shape of the flat surface is formed by a roundish curve. In an extreme example, it is desirable to employ a round contour shape such as a circle or an ellipse. As a result, abrasion resistance of the particles is enhanced, which is desirable. Furthermore, stress is not likely to be concentrated around the contour shape, the magnetic strain of the flaky magnetic metal particle is reduced, coercivity is decreased, and the hysteresis loss is reduced, which is desirable. Since stress concentration is reduced, thermal stability and mechanical characteristics such as strength and toughness are also likely to be enhanced, which is desirable.

It is also preferable that the magnetic metal phase has a portion having a crystal structure of the body-centered cubic structure (bcc). Thereby, appropriately high magnetic anisotropy can be easily induced, and the above-described magnetic characteristics are enhanced, which is therefore preferable. Also with a “crystal structure of a mixed phase of bcc and face-centered cubic (fcc)”, which partially has the fcc crystal structure, appropriately high magnetic anisotropy can be easily induced, and the above-described magnetic characteristics are enhanced, which is therefore preferable.

It is preferable that the flat surfaces of the flaky magnetic metal particles are crystallographically approximately oriented. The direction of orientation is preferably the (110) plane orientation. Thereby, appropriately high magnetic anisotropy can be easily induced, and the above-described magnetic characteristics are enhanced. Therefore, it is preferable. A more preferred direction of orientation is the (110)[111] direction. Thereby, appropriately high magnetic anisotropy can be easily induced, and the above-described magnetic characteristics are enhanced, which is therefore preferable. The crystal planes of the flat surface of the flaky magnetic metal particles are such that the peak intensity ratio of a crystal plane other than the (110) (220) plane (for example, (200), (211), (310), or (222)) with respect to (110) as measured by X-ray diffractometry (XRD) is preferably 10% or less, more preferably 5% or less, and even more preferably 3% or less. Thereby, appropriately high magnetic anisotropy can be easily induced, and the above-described magnetic characteristics are enhanced, which is therefore preferable.

Furthermore, the flaky magnetic metal particles have a magnetic metal phase containing at least one first element selected from the group consisting of Fe, Co, and Ni. Meanwhile, the flaky magnetic metal particles contain Fe and Co, and it is preferable that the amount of Co is from 10 at % to 60 at % with respect to the total amount of Fe and Co, while it is more preferable that from 10 at % to 40 at % of Co is included. Thereby, appropriately high magnetic anisotropy is likely to be induced, and the above-described magnetic characteristics are enhanced, which is therefore preferable. Furthermore, an Fe—Co system is preferred because high saturation magnetization can be easily realized. Furthermore, when the composition range of Fe and Co is included in the above-described range, higher saturation magnetization can be realized, which is preferable. In addition, when the compositions of the flaky magnetic metal particles and the extraneous metal particles are equal, thermal stability and mechanical characteristics such as strength and hardness are easily enhanced, which is preferable.

It is preferable that the flaky magnetic metal particles contain at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements. Thereby, the thermal stability and oxidation resistance of the flaky magnetic metal particles can be enhanced. Among them, Al and Si are particularly preferred because these elements can easily form solid solutions with Fe, Co, and Ni, which are main components of the flaky magnetic metal particles and contribute to enhancement of thermal stability and oxidation resistance.

Furthermore, in order to induce magnetic anisotropy, there is also a method of amorphizing the crystallinity of the flaky magnetic metal particles as far as possible and inducing magnetic anisotropy in one direction within the flat surface by a magnetic field or strain. In this case, it is desirable to employ a composition that can easily amorphize the flaky magnetic metal particles as far as possible. From such a viewpoint, it is preferable that the magnetic metal included in the flaky magnetic metal particles includes at least one additive element selected from the group consisting of B (boron), Si (silicon), Al (aluminum), C (carbon), Ti (titanium), Zr (zirconium), Hf (hafnium), Nb (niobium), Ta (tantalum), Mo (molybdenum), Cr (chromium), Cu (copper), W (tungsten), P (phosphorus), N (nitrogen), Ga (gallium), and Y (yttrium). An additive element having a large difference in the atomic radius from at least one first element selected from the group consisting of Fe, Co, and Ni is preferred. Furthermore, an additive element whose enthalpy of mixing between at least one first element selected from the group consisting of Fe, Co, and Ni and the additive element acquires a larger negative value, is preferred. It is also preferable that the flaky magnetic metal particles are formed from a multicomponent system composed of three or more kinds of elements in total, including a first element and an additive element. It is advantageous to mix semi-metal additive elements such as B and Si into the system because the semi-metal additive elements have slow rates of crystallization and are easily amorphized. From the viewpoint such as described above, B, Si, P, Ti, Zr, Hf, Nb, Y, Cu, and the like are preferred, and above all, it is more preferable that the additive elements include any one of B, Si, Zr, Hf, and Y. As an example, it is preferable that the flaky magnetic metal particles include Fe and Co as first elements of the magnetic metal phase and include Si and B as the additive element. It is also preferable that the total amount of the additive element is from 0.001 at % to 80 at % in total with respect to the total amount of the first element and the additive element. The total amount is more preferably from 5 at % to 80 at %, and even more preferably from 10 at % to 40 at %. As the total amount of the additive element is larger, amorphization proceeds, and magnetic anisotropy is easily induced, which is preferable (that is, it is preferable from the viewpoints of low loss and high magnetic permeability); however, on the other hand, since the proportion of the magnetic metal phase becomes smaller, it is not preferable from the viewpoint that saturation magnetization is decreased. However, depending on the use application (for example, magnetic wedges of a motor), the flaky magnetic metal particles can be used satisfactorily even in a case in which the saturation magnetization is relatively low, and it may be rather preferable that the flaky magnetic metal particles are specialized for low losses and high magnetic permeability. Meanwhile, the magnetic wedges of a motor are lid-like objects for the slot parts into which coils are inserted, and usually, non-magnetic wedges are used. However, when magnetic wedges are employed, the sparseness or denseness of the magnetic flux density is moderated, the harmonic loss is reduced, and the motor efficiency is increased. At this time, it is preferable that saturation magnetization of the magnetic wedges is higher; however, even with relatively low saturation magnetization (for example, about 0.5 to 1 T), sufficient effects are exhibited. Therefore, it is important to select the composition and the amounts of additive elements depending on the use application.

It is preferable that the flaky magnetic metal particles have high saturation magnetization, and the saturation magnetization is preferably 1 T or greater, more preferably 1.5 T or greater, even more preferably 1.8 T or greater, and still more preferably 2.0 T or greater. Thereby, magnetic saturation is suppressed, and magnetic characteristics can be exhibited sufficiently in the system, which is preferable. However, depending on the use application (for example, magnetic wedges of a motor), the flaky magnetic metal particles can be used sufficiently even in a case in which the saturation magnetization is relatively low, and it may be rather preferable that the flaky magnetic metal particles are specialized for low losses. Meanwhile, the magnetic wedges of a motor are lid-like objects for the slot parts into which coils are inserted. Usually, non-magnetic wedges are used; however, when magnetic wedges are employed, the sparseness or denseness of the magnetic flux density is moderated, the harmonic loss is reduced, and the motor efficiency is increased. At this time, it is preferable that saturation magnetization of the magnetic wedges is higher; however, even with relatively low saturation magnetization, sufficient effects are exhibited. Therefore, it is important to select the composition depending on the use application.

The average crystal grain size of the magnetic metal phase is preferably 1 μm or more, more preferably 10 μm or more, even more preferably 50 μm or more, and still more preferably 100 μm or more. When the average crystal grain size of the magnetic metal phase increases, the proportion of the surface of the magnetic metal phase is decreased, and therefore, the pinning sites are reduced. Thereby, coercivity is reduced, and the hysteresis loss is reduced, which is preferable. Furthermore, when the average crystal grain size of the magnetic metal phase increases within the range described above, appropriately high magnetic anisotropy can be easily induced, and the above-described magnetic characteristics are enhanced, which is therefore preferable.

Furthermore, the average crystal grain size of the magnetic metal phase is preferably 100 nm or less, more preferably 50 nm or less, even more preferably 20 nm or less, and still more preferably 10 nm or less. It is more preferable as the average crystal grain size is smaller, and the average crystal grain size is more preferably 5 nm or less, and even more preferably 2 nm or less. Thereby, anisotropy can be easily induced, and the above-described magnetic characteristics are enhanced, which is therefore preferable. Furthermore, since a smaller average crystal grain size means that the substance is closer to amorphousness, electrical resistance is increased compared to highly crystalline substances, and thereby the eddy current loss is likely to be reduced, which is preferable. Also, it is preferable because the magnetic metal phase is excellent in terms of corrosion resistance and oxidation resistance as compared to highly crystalline substances.

Meanwhile, an average crystal grain size of 100 nm or less can be calculated simply by Scherrer's formula based on XRD measurement, and the crystal grain size can also be determined by making an observation of a large number of magnetic metal phases by transmission electron microscope (TEM) observation and averaging the particle sizes of the magnetic metal phases. In a case in which the average crystal grain size is small, it is preferable to determine the average crystal grain size by XRD measurement, and in a case in which the average crystal grain size is large, it is preferable to determine the average crystal grain size by TEM observation. However, it is preferable to select the measurement method according to the circumstances, or to use the two methods in combination and determine the average crystal grain size in a comprehensive manner.

The lattice strain of the flaky magnetic metal particles is preferably from 0.01% to 10%, more preferably from 0.01% to 5%, even more preferably from 0.01% to 1%, and still more preferably from 0.01% to 0.5%. Thereby, appropriately high magnetic anisotropy can be easily induced, and the above-described magnetic characteristics are enhanced, which is therefore preferable.

Meanwhile, the lattice strain can be calculated by analyzing in detail the line widths obtainable by X-ray diffraction (XRD). That is, by drawing a Halder-Wagner plot or a Hall-Williamson plot, the extent of contribution made by expansion of the line width can be separated into the crystal grain size and the lattice strain. The lattice strain can be calculated thereby. A Halder-Wagner plot is preferable from the viewpoint of reliability. In regard to the Halder-Wagner plot, for example, N. C. Halder, C. N. J. Wagner, Acta Cryst., 20 (1966), 312-313 may be referred to. Here, a Halder-Wagner plot is represented by the following expression:

$$( β \text{:} , K : , λ \text{:} , D \text{:} , \sqrt{{ɛ}^{2}} : \\ \frac{{β}^{2}}{{tan}^{2 } θ} = \frac{K λ}{D} \frac{β}{tan θ sin θ} + 16 {ɛ}^{2} , ɛ = {ɛ}_{max} = \frac{\sqrt{2 π}}{2} \sqrt{{ɛ}^{2}} \\ ( β \text{:} integrated width , K \text{:} constant , λ \text{:} wavelength , \\ D \text{:} crystal grain size , \sqrt{{ɛ}^{2}} \text{:} lattice strain ( root \text{-} mean \text{-} square ) ) \qquad [ Math . 1 ]$$

That is, β²/tan²θ is plotted on the vertical axis, and β/tan θ sin θ is plotted on the horizontal axis. The crystal grain size D is calculated from the gradient of the approximation straight line of the plot, and the lattice strain ε is calculated from the ordinate intercept. When the lattice strain obtained by a Halder-Wagner plot of the expression described above (lattice strain (root-mean-square)) is from 0.01% to 10%, more preferably from 0.01% to 5%, even more preferably from 0.01% to 1%, and still more preferably from 0.01% to 0.5%, appropriately high magnetic anisotropy can be easily induced, and the above-described magnetic characteristics are enhanced, which is therefore preferable.

The lattice strain analysis described above is a technique that is effective in a case in which a plurality of peaks can be detected by XRD; however, on the other hand, in a case in which the peak intensities in XRD are weak, and there are few peaks that can be detected (for example, when only one peak is detected), it is difficult to perform an analysis. In such a case, it is preferable to calculate the lattice strain by the following procedure. First, the composition is determined by high-frequency inductively coupled plasma (ICP) emission spectroscopy, energy dispersive X-ray spectroscopy (EDX), or the like, and the composition ratio of three magnetic metal elements, namely, Fe, Co and Ni, is calculated (in a case in which there are only two magnetic metal elements, the composition ratio of two elements; in a case in which there is only one magnetic metal element, the composition ratio of one element (=100%)). Next, an ideal lattice spacing d₀ is calculated from the composition of Fe—Co—Ni (refer to the values published in the literature, or the like. In some cases, an alloy having the composition is produced, and the lattice spacing is calculated by making a measurement). Subsequently, the amount of strain can be determined by determining the difference between the lattice spacing d of the peaks of an analyzed sample and the ideal lattice spacing d₀. That is, in this case, the amount of strain is calculated by the expression: (d−d₀)/d₀×100(%). Thus, in regard to the analysis of the lattice strain, it is preferable to use the two above-described techniques appropriately depending on the state of peak intensity, and depending on cases, it is preferable to evaluate the lattice strain by using the two techniques in combination.

The lattice spacing in the flat surface varies depending on the direction, and the proportion of the difference between the maximum lattice spacing dₘₐₓ and the minimum lattice spacing dₘᵢₙ (=(dₘₐₓ−dₘᵢₙ)/dₘᵢₙ×100(%)) is preferably from 0.01% to 10%, more preferably from 0.01% to 5%, even more preferably from 0.01% to 1%, and still more preferably from 0.01% to 0.5%. Thereby, appropriately high magnetic anisotropy can be easily induced, and the above-described magnetic characteristics are enhanced, which is therefore preferable. Furthermore, the lattice spacing can be conveniently determined by an XRD measurement. When this XRD measurement is carried out while the direction is varied within a plane, the differences in the lattice constant depending on the direction can be determined.

In regard to crystallites of the flaky magnetic metal particles, it is preferable that either the crystallites are unidirectionally linked in a row within the flat surface, or the crystallites are rod-shaped and are unidirectionally oriented in the flat surface. Thereby, appropriately high magnetic anisotropy can be easily induced, and the above-described magnetic characteristics are enhanced, which is therefore preferable.

It is preferable that the flat surface of a flaky magnetic metal particle has either or both of a plurality of concavities and a plurality of convexities, the concavities and the convexities being arranged in a first direction and each of the concavities and the convexities having a width of 0.1 μm or more, a length of 1 μm or more, and an aspect ratio of 2 or higher. Thereby, magnetic anisotropy is easily induced in the first direction, and the difference in coercivity on the basis of direction within the flat surface is increased, which is preferable. From this point of view, it is more preferable that the width is 1 μm or more and the length is 10 μm or more. The aspect ratio is preferably 5 or higher, and more preferably 10 or higher. Furthermore, by including such concavities or convexities, the adhesiveness between the flaky magnetic metal particles is enhanced at the time of synthesizing a pressed powder material by powder-compacting the flaky magnetic metal particles (the concavities or convexities bring an anchoring effect of attaching the particles to neighboring particles), and thereby, thermal stability and mechanical characteristics such as strength and hardness are enhanced. Therefore, it is preferable.

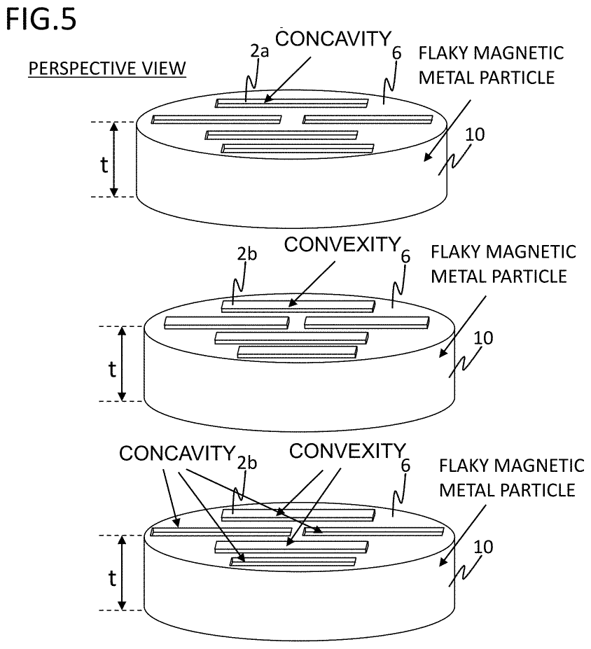

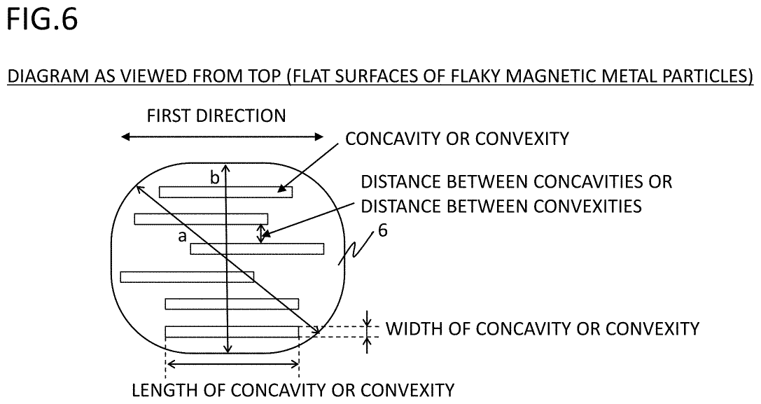

FIG. 5 is a schematic perspective view of the flaky magnetic metal particles in the pressed powder material according to the first embodiment. Meanwhile, in the upper diagram of FIG. 5, only concavities are provided, and in the middle diagram of FIG. 5, only convexities are provided; however, as illustrated in the lower diagram of FIG. 5, one flaky magnetic metal particle may have both concavities and convexities. FIG. 6 is a schematic diagram of a flaky magnetic metal particle according to the first embodiment as viewed from above. The width and length of the concavities or convexities, and the distance between concavities or convexities are illustrated. One flaky magnetic metal particle may have both concavities and convexities. The aspect ratio of a concavity or a convexity is the ratio of the length of the major axis to the length of the minor axis. That is, when the length side of a concavity or a convexity is larger (longer) than the width, the aspect ratio is defined as the ratio of length to width, and when the width is larger (longer) than the length, the aspect ratio is defined as the ratio of width to length. As the aspect ratio is higher, the flaky magnetic metal particle is more likely to exhibit magnetically uniaxial anisotropy (anisotropy), which is more preferable. FIG. 6 illustrates concavities 2a, convexities 2b, flat surfaces 6, and flaky magnetic metal particles 10.

Furthermore, the phrase “(being) arranged in the first direction” implies that concavities or convexities are arranged such that the longer side between the length and the width of the concavities or the convexities is parallel to the first direction. Meanwhile, when concavities or convexities are arranged such that the longer side between the length and the width of the concavities or the convexities is within ±30° in a direction parallel to the first direction, it is said that the concavities or convexities are “arranged in the first direction”. Thereby, the flaky magnetic metal particles are likely to exhibit magnetically uniaxial anisotropy in the first direction by a shape magnetic anisotropy effect, which is preferable. It is preferable that the flaky magnetic metal particles exhibit a magnetic anisotropy in one direction within the flat surface, and this will be described in detail. First, in a case in which the magnetic domain structure of the flaky magnetic metal particles is a multi-domain structure, the magnetization process proceeds by domain wall displacement; however, in this case, the coercivity in the easy axis direction within the flat surface becomes lower than that in the hard axis direction, and losses (hysteresis loss) are decreased. Furthermore, magnetic permeability in the easy axis direction becomes higher than that in the hard axis direction. Furthermore, compared to the case of flaky magnetic metal particles that are isotropic, particularly the coercivity in the easy axis direction becomes lower in the case of flaky magnetic metal particles exhibiting magnetic anisotropy, and as a result, losses become smaller, which is preferable. Also, magnetic permeability becomes high, and it is preferable. That is, when the flaky magnetic metal particles exhibit magnetic anisotropy in a direction in the flat surface, magnetic characteristics are enhanced as compared to an isotropic material. Particularly, magnetic characteristics are superior in the easy axis direction in the flat surface than in the hard axis direction, which is preferable. Next, in a case in which the magnetic domain structure of the flaky magnetic metal particles is a single domain structure, the magnetization process proceeds by rotation magnetization; however, in this case, the coercivity in the hard axis direction in the flat surface becomes lower than that in the easy axis direction, and losses become small. In a case in which magnetization proceeds completely by rotation magnetization, the coercivity becomes zero, and the hysteresis loss becomes zero, which is preferable. Meanwhile, whether magnetization will proceed by domain wall displacement (domain wall displacement type) or by rotation magnetization (rotation magnetization type) can be determined on the basis of whether the magnetic domain structure becomes a multi-domain structure or a single domain structure. At this time, whether the magnetic domain structure becomes a multi-domain structure or a single domain structure is determined on the basis of the size (thickness or aspect ratio) of the flaky magnetic metal particles, composition, the condition of the magnetic interaction between particles, and the like. For example, as the thickness t of the flaky magnetic metal particles is smaller, the magnetic domain structure is more likely to become a single domain structure, and when the thickness is from 10 nm to 1 μm, and particularly when the thickness is from 10 nm to 100 nm, the magnetic domain structure is likely to become a single domain structure. Regarding the composition, in a composition having high magnetocrystalline anisotropy, even if the thickness is large, it tends to be easy to maintain a single domain structure. In a composition having low magnetocrystalline anisotropy, if the thickness is not small, it tends to be difficult to maintain a single domain structure. That is, the thickness of the borderline between being a single domain structure or a multi-domain structure varies depending also on the composition. Furthermore, when the flaky magnetic metal particles magnetically interact with neighboring particles, and the magnetic domain structure is stabilized, the magnetic domain structure is likely to become a single domain structure. The determination of whether the magnetization behavior is of the domain wall displacement type or of the rotation magnetization type can be made simply as follows. First, within a plane of the material (a plane that is parallel to the flat surface of a flaky magnetic metal particle), magnetization is analyzed by varying the direction in which a magnetic field is applied, and two directions in which the difference in the magnetization curve becomes the largest (at this time, the two directions are directions tilted by 90° from each other) are found out. Next, a comparison is made between the curves of the two directions, and thereby it can be determined whether the magnetization behavior is of the domain wall displacement type or the rotation magnetization type.

As described above, it is preferable that the flaky magnetic metal particles exhibit magnetic anisotropy in one direction within the flat surface; however, more preferably, when the flaky magnetic metal particles have either or both of a plurality of concavities and a plurality of convexities, the concavities or convexities being arranged in a first direction, and each of the concavities and the convexities having a width of 0.1 μm or more, a length of 1 μm or more, and an aspect ratio of 2 or higher, magnetic anisotropy is more easily induced in the first direction, which is more preferable. From this point of view, a width of 1 μm or more and a length of 10 μm or more are more preferred. The aspect ratio is preferably 5 or higher, and more preferably 10 or higher. By having such concavities or convexities provided on the flaky magnetic metal particles, the adhesiveness between the flaky magnetic metal particles is enhanced at the time of synthesizing a pressed powder material by powder-compacting the flaky magnetic metal particles (the concavities or convexities bring an anchoring effect of attaching the particles to neighboring particles). As a result, mechanical characteristics such as strength and hardness, and thermal stability are enhanced, and therefore, it is preferable.

In regard to the flaky magnetic metal particles, it is preferable that the largest portion of the first directions of either or both of a plurality of concavities and a plurality of convexities is arranged in the direction of the easy magnetization axis. That is, in a case in which there are a large number of directions of arrangement (=first directions) in the flat surface of a flaky magnetic metal particle, it is preferable that the direction of arrangement (=first direction) that accounts for the largest proportion in the large number of directions of arrangement (=first directions), coincides with the direction of the easy axis of the flaky magnetic metal particles. Since the length direction in which the concavities or convexities are arranged, namely, the first direction, is likely to become the easy magnetization axis as a result of the effect of shape magnetic anisotropy, when the flaky magnetic metal particles are oriented with respect to this direction as the easy magnetization axis, magnetic anisotropy can be easily induced, which is preferable.

In regard to either or both of a plurality of concavities and a plurality of convexities, it is desirable that five or more on the average of those are included in one flaky magnetic metal particle. Here, five or more concavities may be included, five or more convexities may be included, or the sum of the number of concavities and the number of convexities may be 5 or larger. More preferably, it is desirable that ten or more of concavities or convexities are included. It is also desirable that the average distance in the width direction between the respective concavities or convexities is from 0.1 μm to 100 μm. It is also desirable that a plurality of extraneous metal particles containing at least one first element selected from the group consisting of Fe, Co and Ni and having an average size of from 1 nm to 1 μm, is arranged along the concavities or convexities. Regarding the method for determining the average size of the extraneous metal particles, the average size is calculated by averaging the sizes of a plurality of extraneous metal particles arranged along the concavities or convexities, based on observation by TEM, SEM, optical microscopy, or the like. When these conditions are satisfied, magnetic anisotropy is easily induced in one direction, which is preferable. Furthermore, the adhesiveness between the flaky magnetic metal particles is enhanced when a pressed powder material is synthesized by powder-compacting the flaky magnetic metal particles (the concavities or convexities bring an anchoring effect of attaching the particles to neighboring particles), and thereby, mechanical characteristics such as strength and hardness, and thermal stability are enhanced, which is preferable.

It is desirable that each of the flaky magnetic metal particles further includes a plurality of small magnetic metal particles, that is, five or more particles on the average, on the flat surface. The small magnetic metal particles contain at least one first element selected from the group consisting of Fe, Co, and Ni, and the average particle size is from 10 nm to 1 μm. More preferably, the small magnetic metal particles have a composition that is equal to that of the flaky magnetic metal particles. As the small magnetic metal particles are provided on the surface of the flat surface, or the small magnetic metal particles are integrated with the flaky magnetic metal particles, the surface of the flaky magnetic metal particles is brought to an artificially slightly damaged state. As a result, when the flaky magnetic metal particles are powder-compacted together with an intercalated phase that will be described below, adhesiveness is greatly enhanced. Thereby, thermal stability and mechanical characteristics such as strength and toughness can be easily enhanced. In order to exhibit such effects at the maximum level, it is desirable that the average particle size of the small magnetic metal particles is adjusted to be from 10 nm to 1 μm, and five or more small magnetic metal particles on the average are integrated with the surface, that is, the flat surface, of the flaky magnetic metal particles. Meanwhile, when the small magnetic metal particles are unidirectionally arranged within the flat surface, magnetic anisotropy can be easily induced in the flat surface, and high magnetic permeability and low losses can be easily realized. Therefore, it is more preferable. The average particle size of the small magnetic metal particles is determined by observing the particles by TEM, SEM, optical microscopy, or the like.

The variation in the particle size distribution of the flaky magnetic metal particles can be defined by the coefficient of variation (CV value). That is, CV value (%)=[standard deviation of particle size distribution (μm)/average particle size (μm)]×100. It can be said that as the CV value is smaller, a sharp particle size distribution with less variation in the particle size distribution is obtained. When the CV value defined as described above is from 0.1% to 60%, low coercivity, low hysteresis loss, high magnetic permeability, and high thermal stability can be realized, which is preferable. Furthermore, since the variation is small, it is also easy to realize a high yield. A more preferred range of the CV value is from 0.1% to 40%.

One effective method for inducing the difference in coercivity on the basis of direction within the flat surface of a flaky magnetic metal particle is a method of subjecting the flaky magnetic metal particle to a heat treatment in a magnetic field. It is desirable to perform a heat treatment while a magnetic field is applied unidirectionally within the flat surface. Before the heat treatment is performed in a magnetic field, it is desirable to find the easy axis direction within the flat surface (find the direction in which coercivity is lowest), and to perform the heat treatment while applying a magnetic field in that direction. It is more preferable if the magnetic field to be applied is larger, and it is preferable to apply a magnetic field of 1 kOe or greater, while it is more preferable to apply a magnetic field of 10 kOe or greater. As a result, magnetic anisotropy can be exhibited in the flat surfaces of the flaky magnetic metal particles, the difference in coercivity on the basis of direction can be induced, and excellent magnetic characteristics can be realized. Therefore, it is preferable. The heat treatment is preferably carried out at a temperature of from 50° C. to 800° C. Regarding the atmosphere for the heat treatment, a vacuum atmosphere at a low oxygen concentration, an inert atmosphere, or a reducing atmosphere is desirable. More desirably, a reducing atmosphere of H₂ (hydrogen), CO (carbon monoxide), CH₄ (methane), or the like is preferred. The reason for this is that even if the flaky magnetic metal particles have been oxidized, the oxidized metal can be reduced and restored into simple metal by subjecting the metal particles to a heat treatment in a reducing atmosphere. As a result, flaky magnetic metal particles that have been oxidized and have lowered saturation magnetization can be reduced, and thereby saturation magnetization can also be restored. When crystallization of the flaky magnetic metal particles proceeds noticeably due to the heat treatment, characteristics are deteriorated (coercivity increases, and magnetic permeability decreases). Therefore, it is preferable to select the conditions so as to suppress excessive crystallization.

Furthermore, when flaky magnetic metal particles are synthesized, in a case in which the flaky magnetic metal particles are obtained by synthesizing a ribbon by a roll quenching method or the like and pulverizing this ribbon, either or both of a plurality of concavities and a plurality of convexities can be easily arranged in the first direction at the time of ribbon synthesis (concavities or convexities can be easily attached in the direction of rotation of the roll). As a result, the difference in coercivity on the basis of direction can be easily induced within the flat surface, and it is therefore preferable. That is, the direction in which either or both of a plurality of concavities and a plurality of convexities are arranged in the first direction within the flat surface, is likely to become the direction of the easy magnetization axis, and the difference in coercivity on the basis of direction is effectively induced within the flat surface, which is preferable.

The flaky magnetic metal particles are preferably such that at least a portion of the surface of the flaky magnetic metal particles is covered with a coating layer that has a thickness of from 0.1 nm to 1 μm and contains at least one second element selected from the group consisting of oxygen (O), carbon (C), nitrogen (N), and fluorine (F).

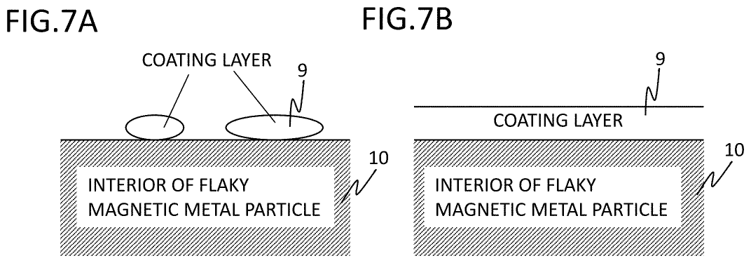

FIGS. 7A and 7B are schematic diagrams of flaky magnetic metal particles in the pressed powder material according to the first embodiment. The diagrams illustrate a coating layer 9.

It is more preferable that the coating layer contains at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements, and also contains at least one second element selected from the group consisting of oxygen (O), carbon (C), nitrogen (N), and fluorine (F). The non-magnetic metal is particularly preferably Al or Si, from the viewpoint of thermal stability. In a case in which the flaky magnetic metal particles contain at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements, it is more preferable that the coating layer contains at least one non-magnetic metal that is the same as the non-magnetic metal as one of the constituent components of the flaky magnetic metal particles. Among oxygen (O), carbon (C), nitrogen (N), and fluorine (F), it is preferable that the coating layer contains oxygen (O), and it is preferable that coating layer contains an oxide or a composite oxide. This is from the viewpoints of the ease of formation of the coating layer, oxidation resistance, and thermal stability. As a result of the above-described matters, the adhesiveness between the flaky magnetic metal particles and the coating layer can be enhanced, and the thermal stability and oxidation resistance of the pressed powder material that will be described below can be enhanced. The coating layer can not only enhance the thermal stability and oxidation resistance of the flaky magnetic metal particles but also enhance the electrical resistance of the flaky magnetic metal particles. By increasing the electrical resistance, the eddy current loss can be suppressed, and the frequency characteristics of the magnetic permeability can be enhanced. Therefore, it is preferable that a coating layer 14 is electrically highly resistant, and for example, it is preferable that the coating layer 14 has an electrical resistance value of 1 mΩ·cm or greater.

Furthermore, the presence of the coating layer is preferable also from the viewpoint of magnetic characteristics. In regard to the flaky magnetic metal particles, since the size of the thickness is small relative to the size of the flat surface, the metal particles may be regarded as a pseudo-thin film. At this time, a product obtained by forming a coating layer on the surface of the flaky magnetic metal particles and integrating the coating layer with the particles may be considered to have a laminated pseudo-thin film structure, and the magnetic domain structure is stabilized in terms of energy. As a result, coercivity can be reduced (hysteresis loss is reduced thereby), which is preferable. At this time, the magnetic permeability also becomes high, and it is preferable. From such a viewpoint, it is more preferable that the coating layer is non-magnetic (magnetic domain structure is easily stabilized).

From the viewpoints of thermal stability, oxidation resistance, and electrical resistance, it is more preferable as the thickness of the coating layer is larger. However, if the thickness of the coating layer is too large, the saturation magnetization becomes small, and the magnetic permeability also becomes small, which is not preferable. Furthermore, also from the viewpoint of magnetic characteristics, if the thickness is too large, the “effect by which the magnetic domain structure is stabilized, and a decrease in coercivity, a decrease in losses, and an increase in magnetic permeability are brought about” is reduced. In consideration of the above-described matters, a preferred thickness of the coating layer is from 0.1 nm to 1 μm, and more preferably from 0.1 nm to 100 m.

It is preferable that saturation magnetization of the pressed powder material is high, and the saturation magnetization is preferably 0.2 T or higher, more preferably 0.5 T or higher, even more preferably 1.0 T or higher, still more preferably 1.8 T or higher, and even more preferably 2.0 T or higher. Thereby, magnetization saturation is suppressed, and the magnetic characteristics can be sufficiently exhibited in the system, which is preferable. However, depending on the use application (for example, magnetic wedges of a motor), the magnetic material can be used satisfactorily even in a case in which saturation magnetization is relatively low, and it is preferable that the magnetic material is rather specialized for low losses. Therefore, it is important to select the composition according to the use applications.

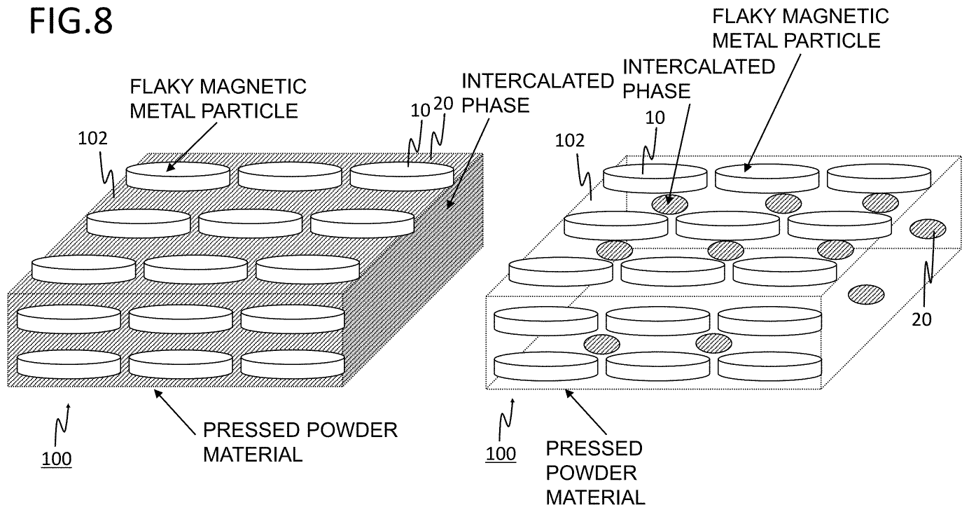

FIG. 8 is a schematic diagram of the pressed powder material according to the first embodiment. The diagram illustrates an intercalated phase 20, a pressed powder material 100, and a plane 102 of the pressed powder material. The diagram illustrated in the right-hand side of FIG. 8 is a schematic diagram produced by removing hatching from the diagram illustrated in the left-hand side of FIG. 8, in order to make the intercalated phase easily recognizable.

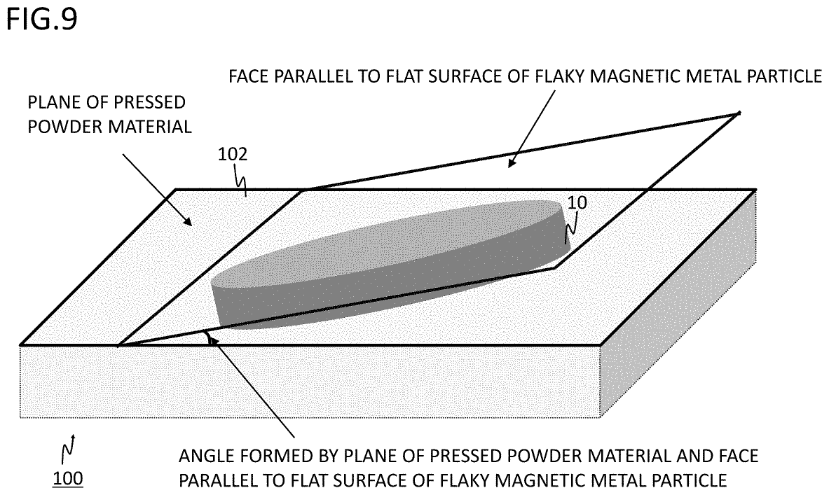

As the angle formed by a face parallel to the flat surface of a flaky magnetic metal particle and a plane of the pressed powder material is closer to 0°, it is defined that the flaky magnetic metal particle is oriented. FIG. 9 is a schematic diagram illustrating the angle formed by a face parallel to the flat surface of a flaky magnetic metal particle and a plane of the pressed powder material, according to the first embodiment. The above-mentioned angle is determined for a large number, that is, ten or more, of flaky magnetic metal particles, and it is desirable that the average value of the angles is preferably from 0° to 45°, more preferably from 0° to 30°, and even more preferably from 0° to 10°. That is, in regard to a pressed powder material, it is preferable that the flat surfaces of the flaky magnetic metal particles are oriented into a layered form such that the flat surfaces are parallel to one another or approximately parallel to one another. Thereby, the eddy current loss of the pressed powder material can be reduced, which is preferable. Furthermore, since the demagnetizing field can be made small, the magnetic permeability of the pressed powder material can be made high, which is preferable. Furthermore, since the ferromagnetic resonance frequency can be made high, the ferromagnetic resonance loss can be made small, which is preferable. Furthermore, such a laminated structure is preferable because the magnetic domain structure is stabilized, and low magnetic loss can be realized.

In the case of measuring the coercivity on the basis of direction within the plane (within a plane parallel to the flat surface of a flaky magnetic metal particle) of the pressed powder material, the coercivity is measured by, for example, varying the direction at an interval of 22.5° over the angle of 360° in the plane.

By having the difference in coercivity within the above-mentioned plane of the pressed powder material, the minimum coercivity value becomes small compared to an isotropic case in which there is almost no difference in coercivity, and thus it is preferable. A material exhibiting magnetic anisotropy within the plane has the difference in coercivity on the basis of direction within the plane, and the minimum coercivity value becomes small compared to a magnetically isotropic material. As a result, the hysteresis loss is reduced, and the magnetic permeability is increased, which is preferable.

In the above-mentioned plane of the pressed powder material (in the plane parallel to the flat surface of a flaky magnetic metal particle), it is more preferable as the proportion of the difference in coercivity on the basis of direction is larger, and the proportion is preferably 1% or greater. The proportion of the difference in coercivity is more preferably 10% or greater; the proportion of the difference in coercivity is even more preferably 50% or greater; and the proportion of the difference in coercivity is still more preferably 100% or greater. The proportion of the difference in coercivity as used herein is defined by the formula: (Hc(max)−Hc(min))/Hc(min)×100(%), by using the maximum coercivity, Hc(max), and the minimum coercivity, Hc(min), within a flat surface.

Meanwhile, coercivity can be evaluated conveniently by using a vibrating sample magnetometer (VSM) or the like. When the coercivity is low, even a coercivity of 0.1 Oe or less can be measured using a low magnetic field unit. Measurement is carried out by varying the direction within the above-mentioned plane of the pressed powder material (within the plane parallel to the flat surface of a flaky magnetic metal particle) with respect to the direction of the magnetic field to be measured.

When coercivity is calculated, α value obtained by dividing the difference between the magnetic fields at two points that intersect with the axis of abscissa (magnetic fields H1 and H2 where magnetization is zero) by 2 can be employed (that is, coercivity can be calculated by the formula: coercivity=|H2−H1|/2).

From the viewpoint of inducing magnetic anisotropy, it is preferable that the magnetic metal particles are arranged so as to have the maximum length directions aligned. Whether the maximum length directions are aligned is determined by making an observation of the magnetic metal particles included in the pressed powder material by TEM, SEM, optical microscopy or the like, determining the angle formed by the maximum length direction and an arbitrarily determined reference line, and judging the condition according to the degree of variation. Preferably, it is preferable to determine the average degree of variation for twenty or more flaky magnetic metal particles; however, in a case in which an observation of twenty or more flaky magnetic metal particles cannot be made, it is preferable that an observation of as many flaky magnetic metal particles as possible is made, and an average degree of variation is determined for those particles. According to the present specification, it is implied that the maximum length directions are aligned when the degree of variation is in the range of ±30°. It is more preferable that the degree of variation is in the range of ±20°, and it is even more preferable that the degree of variation is in the range of ±10°. As a result, magnetic anisotropy can be easily induced in the pressed powder material, which is desirable. More preferably, it is desirable that the first directions of either or both of a plurality of concavities and a plurality of convexities in the flat surface are arranged in the maximum length direction. Significant magnetic anisotropy can be induced thereby, and thus it is desirable.

In regard to the pressed powder material, it is preferable that the “proportion of arrangement” at which approximate first directions are arranged in a second direction is 30% or higher. The “proportion of arrangement” is more desirably 50% or higher, and even more desirably 75% or higher. As a result, the magnetic anisotropy becomes appropriately high, and the magnetic characteristics are enhanced as described above, which is preferable. First, for all of the flaky magnetic metal particles to be evaluated in advance, the direction in which the direction of arrangement of the concavities or convexities carried by various flaky magnetic metal particles accounts for the largest proportion is defined as a first direction. The direction in which the largest number of the first directions of the various flaky magnetic metal particles are arranged in the pressed powder material as a whole is defined as a second direction. Next, directions obtained by dividing the angle of 360° into angles at an interval of 45° with respect to the second direction are determined. Next, the first directions of the various flaky magnetic metal particles are sorted according to the direction of angle to which the first directions are arranged most closely, and that direction is defined as the “approximate first direction”. That is, the first directions are sorted into four classes, namely, the direction of 0°, the direction of 45°, the direction of 90°, and the direction of 135°. The proportion in which the approximate first directions are arranged in the same direction with respect to the second direction is defined as the “proportion of arrangement”. When this “proportion of arrangement” is evaluated, four consecutive neighboring flaky magnetic metal particles are selected, and the four particles are evaluated. This is carried out repeatedly several times, for at least three or more times (the more the better; for example, five or more times is desirable, and ten or more times is more desirable), and thereby, the average value is employed as the proportion of arrangement. Meanwhile, flaky magnetic metal particles in which the directions of the concavities or the convexities cannot be determined are excluded from the evaluation, and an evaluation of the flaky magnetic metal particles immediately adjacent thereto is performed. For example, in many of flaky magnetic metal particles obtained by pulverizing a ribbon synthesized with a single roll quenching apparatus, concavities or convexities attach only on one of the flat surfaces, and the other flat surface does not have any concavities or convexities attached thereto. When such flaky magnetic metal particles are observed by SEM, the situation in which the flat surface without any concavities or convexities attached thereto is shown on the image of observation may also occur at a probability of about 50% (in this case, too, actually there may be concavities or convexities attached to the flat surface on the rear side; however, these flaky magnetic metal particles have been excluded from the evaluation).

Furthermore, it is preferable that the largest number of the approximate first directions is arranged in the direction of the easy magnetization axis of the pressed powder material. That is, it is preferable that the easy magnetization axis of the pressed powder material is parallel to the second direction. Since the length direction in which the concavities or convexities are arranged is likely to become the easy magnetization axis due to the effect of shape magnetic anisotropy, it is preferable to align the directions by taking this direction as the easy magnetization axis, because magnetic anisotropy is easily induced.

It is preferable that a portion of the intercalated phase is attached along the first direction. In other words, it is preferable that a portion of the intercalated phase is attached along the direction of the concavities or convexities on the flat surfaces of the flaky magnetic metal particles. Thereby, magnetic anisotropy can be easily induced unidirectionally, which is preferable. Such attachment of the intercalated phase is preferable because the adhesiveness between the flaky magnetic metal particles is enhanced, and consequently, mechanical characteristics such as strength and hardness and thermal stability are enhanced. It is also preferable that the intercalated phase includes a particulate phase. As a result, the adhesiveness between the flaky magnetic metal particles is maintained in an adequate state appropriately, strain is reduced (since there is a particulate intercalated phase between the flaky magnetic metal particles, the stress applied to the flaky magnetic metal particles is relieved), and coercivity can be easily reduced (hysteresis loss is reduced, and magnetic permeability is increased), which is preferable.

Regarding the intercalated phase, it is preferable that an amount of from 0.01 wt % to 80 wt %, more preferably from 0.1 wt % to 60 wt %, and even more preferably from 0.1 wt % to 40 wt %, with respect to the total amount of the pressed powder material is included. When the proportion of the intercalated phase is too large, the proportion of the flaky magnetic metal particles that are in charge of magnetic properties becomes small, and therefore, the saturation magnetization and the magnetic permeability of the pressed powder material are reduced, which is not preferable. On the contrary, when the proportion of the intercalated phase is too small, bonding between the flaky magnetic metal particles and the intercalated phase is weakened, and it is not preferable from the viewpoints of thermal stability and mechanical characteristics such as strength and toughness. From the viewpoints of magnetic characteristics such as saturation magnetization and magnetic permeability, thermal stability, and mechanical characteristics, the optimal proportion of the intercalated phase is from 0.01 wt % to 80 wt %, more preferably from 0.1 wt % to 60 wt %, and even more preferably from 0.1 wt % to 40 wt %, with respect to the total amount of the pressed powder material.

Furthermore, it is preferable that the proportion of lattice mismatch between the intercalated phase and the flaky magnetic metal particles is from 0.1% to 50%. Thereby, appropriately high magnetic anisotropy can be easily induced, and the above-described magnetic characteristics are enhanced, which is therefore preferable. In order to set the lattice mismatch to the range described above, the range of lattice mismatch can be realized by selecting the combination of the composition of the intercalated phase and the composition of the flaky magnetic metal particles 10. For example, Ni of the fcc structure has a lattice constant of 3.52 Å, and MgO of the NaCl type structure has a lattice constant of 4.21 Å. Thus, the lattice mismatch of the two is (4.21−3.52)/3.52×100=20%. That is, the lattice mismatch can be set to 20% by employing Ni of the fcc structure as the main composition of the flaky magnetic metal particles and employing MgO for the intercalated phase 20. As such, the lattice mismatch can be set to the range described above by selecting the combination of the main composition of the flaky magnetic metal particles and the main composition of the intercalated phase.

The intercalated phase contains at least one second element selected from the group consisting of oxygen (O), carbon (C), nitrogen (N), and fluorine (F). It is because the electrical resistance can be increased thereby. It is preferable that the electrical resistivity of the intercalated phase is higher than the electrical resistivity of the flaky magnetic metal particles. It is because the eddy current loss of the flaky magnetic metal particles can be reduced thereby. Since the intercalated phase exists so as to surround the flaky magnetic metal particles, the oxidation resistance and thermal stability of the flaky magnetic metal particles can be enhanced, which is preferable. Above all, it is more preferable that the intercalated phase contains oxygen from the viewpoint of having high oxidation resistance and high thermal stability. Since the intercalated phase also plays a role of mechanically adhering flaky magnetic metal particles to neighboring flaky magnetic metal particles, it is preferable also from the viewpoint of high strength.

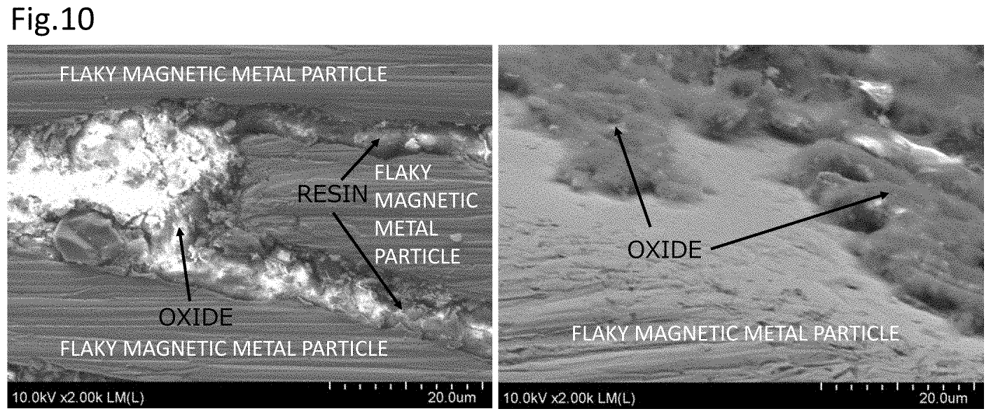

Furthermore, it is preferable that the intercalated phase includes an oxide and a resin, the softening temperature of the oxide is higher than the softening temperature of the resin, and the oxide is fixed to at least a portion of the flaky magnetic metal particles. Meanwhile, the softening temperature is defined as the endothermic peak temperature at the time of softening based on differential scanning calorimetry (DSC). Instead of DSC, other analysis techniques capable of determining the endothermic peak temperature, such as differential thermal analysis (DTA), may also be used. Furthermore, in a case in which there is a plurality of endothermic peaks, the softening temperature is defined as the endothermic peak temperature on the lowest temperature side (hereinafter, the softening temperature complies with this definition in all cases). Meanwhile, in the case of evaluating the endothermic peak of the oxide or the resin, in a case in which the oxide or the resin includes moisture, a solvent, or the like, a broad or sharp peak attributable to the moisture, solvent, or the like may be observed. However, since such a peak is not an endothermal peak associated with softening of an oxide or a resin, the peak may be appropriately ignored. Thus, only an endothermic peak obtainable when an oxide or a resin itself is softened is distinguished, and the peak is used as an object of evaluation. Because it is very important to fix the oxide to at least a portion of the flaky magnetic metal particles, regarding the production method, it is preferable to produce a pressed powder material by a procedure of first sufficiently mixing flaky magnetic metal particles and an oxide, subjecting the mixture to a heat treatment to fix the oxide to at least a portion of the flaky magnetic metal particles, subsequently incorporating a resin therein, and molding the mixture. More preferably, it is preferable to heat the mixture to a temperature higher than or equal to the softening temperature of the oxide during the heat treatment, and thereby fixation of the oxide further proceeds. Also, a method of simultaneously applying pressure and heat, such as hot pressing, a method of applying pressure and then performing a heat treatment, a method of performing a heat treatment and then applying pressure, or the like is also effective. In a case in which the oxide and the flaky magnetic metal particles are hardened, it is preferable to appropriately perform pulverization to granulate the mixture, subsequently mix a resin with the granules, and perform molding. By carrying out the above-described procedure, it becomes possible to effectively fix the oxide to at least a portion of the flaky magnetic metal particles. FIG. 10 shows examples of scanning electron microscopic (SEM) photographs of the pressed powder material according to the first embodiment. It is understood that the oxide is fixed to at least a portion of the flaky magnetic metal particles.

Furthermore, the ratio of the oxide with respect to the resin is preferably from 0.1 to 10 as an area ratio. Thereby, both low coercivity (as well as low hysteresis loss and high magnetic permeability) and high strength can be obtained. Regarding the area ratio, the area of the oxide and the area of the resin are determined from a two-dimensional photograph observed by SEM, optical microscopy, or the like, and the ratio of the areas is employed. For example, it is preferable to determine the area ratio by determining the area in a range including at least ten or more flaky magnetic metal particles, or even for a range including a smaller number of flaky magnetic metal particles (or a range including a portion of a single flaky magnetic metal particle), by averaging the areas at places in a plurality of ranges (for example, 10 sites or more). Whatsoever, it is preferable to determine the area so as to extract average information over the entire pressed powder material.

Furthermore, it is preferable that the softening temperature of the oxide is higher by 10° C. or more, more preferably by 20° C. or more, even more preferably 50° C. or more, and still more preferably 80° C. or more, than the softening temperature of the resin. The softening temperature of the oxide is preferably from 300° C. to 600° C., more preferably from 450° C. to 600° C., even more preferably from 450° C. to 550° C., and still more preferably from 450° C. to 500° C. When the softening temperature is too low, the resulting material is not firmly hardened, and the strength as a pressed powder material is lowered, which is not preferable. On the contrary, when the softening temperature is too high, crystallization of the magnetic metal phase proceeds, and coercivity is increased (deterioration), which is not preferable. By setting the softening temperature to the above-mentioned appropriate range, both low coercivity (as well as low hysteresis loss and high magnetic permeability) and high strength can be obtained.

Furthermore, the softening temperature of the resin is preferably from 200° C. to 500° C., more preferably from 300° C. to 460° C., and even more preferably from 300° C. to 400° C. When the softening temperature is too low, the resulting material is not firmly hardened, and the strength as a pressed powder material is lowered, which is not preferable. On the contrary, when the softening temperature is too high, crystallization of the magnetic metal phase proceeds, and coercivity is increased (deterioration), which is not preferable. By setting the softening temperature to the above-mentioned appropriate range, both low coercivity (as well as low hysteresis loss and high magnetic permeability) and high strength can be obtained.

Furthermore, it is preferable that the softening temperature of the oxide is lower by 50° C. or more than the crystallization temperature of the magnetic metal phase. The crystallization temperature as used herein is not the crystallization peak temperature (exothermic peak temperature) but is defined as the crystallization initiation temperature (for example, determined as the temperature at the intersection of a straight line obtained by extending the baseline on the lower temperature side to the higher temperature side and a tangent line drawn at a point where the gradient on the curve on the lower temperature side of the crystallization peak becomes the largest). In a case in which there is a plurality of crystallization peaks (exothermic peaks), the softening temperature is defined as the initiation temperature of the crystallization peak (exothermic peak) on the lowest temperature side. However, in a case in which the peak of crystallization is broad, and it is difficult to distinguish the crystallization initiation temperature by drawing a gentle curve, the crystallization initiation temperature may be replaced with the crystallization peak temperature. Whether the softening temperature should be determined with the crystallization initiation temperature or with the crystallization peak temperature is appropriately judged in accordance with the peak. Since it is preferable that the softening temperature of the resin is lower than the softening temperature of the oxide, it is preferable that the softening temperatures of the oxide and the resin are lower by 50° C. or more than the crystallization temperature of the magnetic metal phase. In a case in which the magnetic metal phase is an amorphous-like phase, as crystallization proceeds, coercivity increases (deterioration), which is not preferable. Therefore, it is not preferable to expose the magnetic metal phase to heat at a temperature higher than the crystallization temperature of the magnetic metal phase. That is, when a pressed powder material is synthesized, it is necessary to expose the pressed powder material to heat at a temperature near or slightly higher than the softening temperature of the oxide and the resin; however, it is necessary to set the temperature at this time to be lower than the crystallization temperature of the magnetic metal phase. Preferably, it is preferable to set the softening temperatures of the oxide and the resin to be lower by 50° C. or more than the crystallization temperature of the magnetic metal phase. Thereby, low coercivity (as well as low hysteresis loss and high magnetic permeability) is made possible. Furthermore, as the softening temperatures are subjected to temperature setting as such, the magnetic metal phase is in a thermally stable state, and high heat resistance and excellent magnetic characteristics (low coercivity, high magnetic permeability, and the like) can be realized, which is preferable.

In a case in which the intercalated phase is composed of a resin only, since resins themselves have high strength in many cases, the intercalated phase has an advantage that the intercalated phase can firmly harden the flaky magnetic metal particles and is likely to have high strength; however, on the other hand, since the intercalated phase is hardened to have high strength, it has a defect that strain is likely to be applied to the interface between the intercalated phase and the flaky magnetic metal particles, and coercivity is easily increased. In contrast, in a case in which the intercalated phase is composed of an oxide only, since oxides themselves have low strength in many cases, the intercalated phase has a defect that it is slightly difficult to firmly harden the flaky magnetic metal particles, and the intercalated phase does not easily acquire high strength; however, on the other hand, since it is slightly difficult to harden the intercalated phase to have high strength, the intercalated phase has an advantage that strain is not likely to be applied to the interface between the intercalated phase and the flaky magnetic metal particles, and coercivity is likely to be reduced. That is, in a case in which the intercalated phase is composed of a resin only or an oxide only, it is difficult for high strength and low coercivity to be obtained in a well-balanced manner. In contrast, when a resin and an oxide are added under certain particular conditions, it is possible to specifically satisfy both high strength and low coercivity. That is, regarding the oxide, when a stable oxide having a high softening temperature is selected, and a state in which the oxide is fixed to the interface with the flaky magnetic metal particles is achieved, the strain to the flaky magnetic metal particles is mitigated, and coercivity is reduced. Besides, as the resin is disposed around the oxide and the flaky magnetic metal particles, it is possible to realize high strength by firmly hardening the resin.

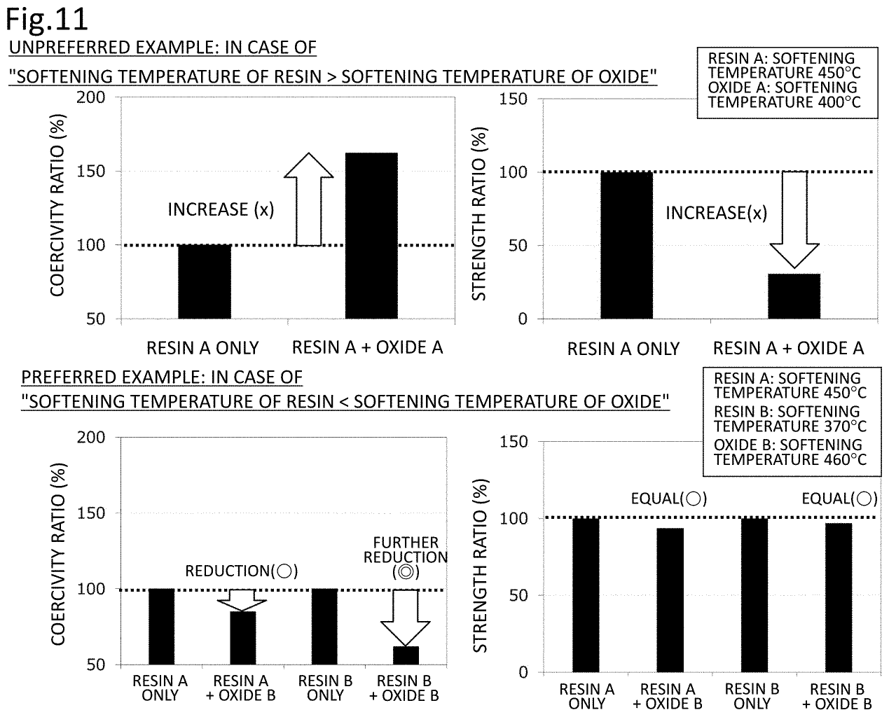

FIG. 11 shows an example of a specific effect in the case of adding a resin and an oxide under particular conditions. The upper diagrams of FIG. 11 show a standard unpreferred example. This example shows a case in which the softening temperature of the resin is higher than the softening temperature of the oxide, representing a specific example with a resin A having a softening temperature of 450° C. and an oxide A having a softening temperature of 400° C. It is understood that in the case of using both the resin A and the oxide A, coercivity is significantly increased as compared to the case of using the resin A alone. Furthermore, with regard to strength, it is understood that in the case of using both the resin A and the oxide A, strength is significantly decreased as compared to the case of using the resin A alone. That is, it is understood that in the case of using both the resin A and the oxide A, it is not preferable from the viewpoint of coercivity as well as from the viewpoint of strength, as compared to the case of using the resin A alone. Incidentally, when high coercivity means a large hysteresis loss and also means that the magnetic permeability is generally small. Therefore, it is preferable neither from the viewpoint of low hysteresis loss nor from the viewpoint of high magnetic permeability. In contrast, the lower diagrams of FIG. 11 show, as a specific preferred example, a case in which the softening temperature of the oxide is higher than the softening temperature of the resin. As specific examples, a case with the resin A having a softening temperature of 450° C. and an oxide B having a softening temperature of 460° C., and a case with the resin B having a softening temperature of 370° C. and the oxide B having a softening temperature of 460° C. will be shown. It is understood that in the case of using both the resin A and the oxide B, coercivity does not increase but is rather significantly decreased, as compared to the case of using the resin A alone. Furthermore, with regard to strength, it is understood that in the case of using both the resin A and the oxide B, strength is almost equal as compared to the case of using the resin A alone. That is, it is understood that in the case of using both the resin A and the oxide B, it is very preferable from the viewpoint of coercivity as well as from the viewpoint of strength, as compared to the case of using the resin A alone. More preferred is the case of using both the resin B and the oxide B. It is understood that in the case of using both the resin B and the oxide B, coercivity is even more significantly decreased as compared to the case of using the resin B alone. Furthermore, with regard to strength, it is understood that in the case of using both the resin B and the oxide B, strength is almost equal as compared to the case of using the resin B alone. That is, it is understood that in the case of using both the resin B and the oxide B, it is more preferable from the viewpoint of coercivity as well as from the viewpoint of strength, as compared to the case of using the resin B alone. The above-described specific effect occurs first in a case in which the softening temperature of the oxide is higher than the softening temperature of the resin, and the specific effect occurs conspicuously in a case in which the softening temperature of the oxide is far higher than the softening temperature of the resin (in the example shown in the lower diagrams of FIG. 11, higher by 80° C. or more). In this regard, when a stable oxide having a high softening temperature is selected as the oxide, and a state in which the oxide is fixed to the interface with the flaky magnetic metal particles is achieved, strain to the flaky magnetic metal particles is mitigated, and coercivity is reduced. Besides, as the resin is disposed around the oxide and the flaky magnetic metal particles, it is possible to realize high strength by firmly hardening the resin. On the other hand, when an oxide having a softening temperature that is lower than the softening temperature of the resin is selected, fluidity of the oxide is increased during molding, it becomes difficult to attain a state in which the oxide is fixed to the interface with the flaky magnetic metal particles, the strain to the flaky magnetic metal particles cannot be mitigated, and coercivity is rather increased (deterioration). Furthermore, the oxide having low strength interrupts and significantly decreases the strength (deterioration). From the above description, in order to obtain low coercivity (as well as low hysteresis loss and high magnetic permeability) and high strength, it is preferable to select a combination in which the softening temperature of the oxide is higher than the softening temperature of the resin. Incidentally, in order to cause this specific effect to be conspicuously exhibited, it is preferable that the ratio of the oxide to the resin is from 0.1 to 10 as an area ratio, and it is preferable that the softening temperature of the oxide is higher by 10° C. or more, more preferably higher by 20° C. or more, even more preferably higher by 50° C. or more, and still more preferably higher by 80° C. or more, than the softening temperature of the resin. The softening temperature of the oxide is preferably from 300° C. to 600° C., more preferably from 450° C. to 600° C., even more preferably from 450° C. to 550° C., and still more preferably from 450° C. to 500° C. Furthermore, the softening temperature of the resin is preferably from 200° C. to 500° C., more preferably from 300° C. to 460° C., and even more preferably from 300° C. to 400° C. Furthermore, it is preferable that the softening temperature of the oxide is lower by 50° C. or more than the crystallization temperature of the magnetic metal phase.

Regarding the oxide, an oxide including at least one element selected from the group consisting of B (boron), Si (silicon), Cr (chromium), Mo (molybdenum), Nb (niobium), Li (lithium), Ba (barium), Zn (zinc), La (lanthanum), P (phosphorus), Al (aluminum), Ge (germanium), W (tungsten), Na (sodium), Ti (titanium), As (arsenic), V (vanadium), Ca (calcium), Bi (bismuth), Pb (lead), Te (tellurium), and Sn (tin) is included. Particularly, it is preferable that the oxide includes B. It is more preferable that the oxide is included in the form of boron oxide.

Regarding the resin, a polyester-based resin, a polyethylene-based resin, a polystyrene-based resin, a polyvinyl chloride-based resin, a polyvinyl butyral resin, a polyvinyl alcohol resin, a polybutadiene-based resin, a TEFLON-based resin, a polyurethane resin, a cellulose-based resin, an ABS resin, a nitrile-butadiene-based rubber, a styrene-butadiene-based rubber, a silicone resin, other synthetic rubbers, natural rubber, an epoxy resin, a phenolic resin, an allyl resin, a polybenzimidazole resin, an amide-based resin, a polyimide-based resin, a polyamideimide resin, or copolymers of those resins are used. Particularly, in order to realize high thermal stability, it is preferable that the intercalated phase includes a silicone resin or a polyimide resin, both of which have high heat resistance. As a result, the bonding between the flaky magnetic metal particles and the intercalated phase becomes strong, and thermal stability and mechanical characteristics such as strength and toughness can be easily enhanced.

Regarding the combination of the oxide and the resin, a combination of “an oxide including boron oxide” and “a resin including a polyimide resin” is more preferred. At this time, it is preferable that the polyimide resin includes a repeating unit represented by the following Chemical Formula (1):

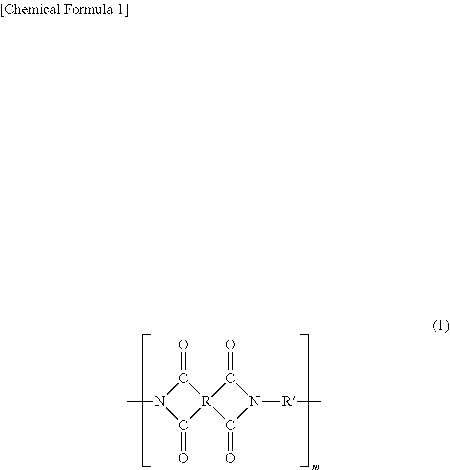

In Chemical Formula (1), it is preferable that R includes any one of a biphenyl structure, a triphenyl structure, and a tetraphenyl structure. It is preferable that R′ represents a structure having at least one or more aromatic rings in the structure.

Furthermore, it is more preferable that the polyimide resin has a structural formula of the following (2) or (3).

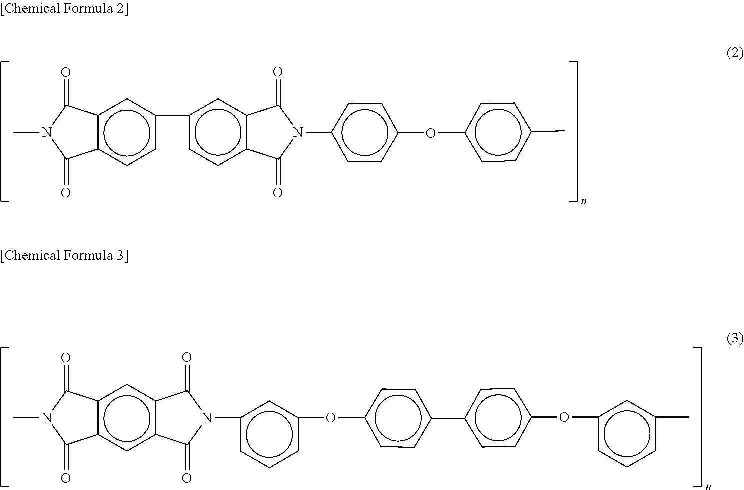

By adopting such a configuration, the softening temperature of the oxide (oxide including boron oxide) becomes about 460° C., and this is included in the above-mentioned range of from 450° C. to 500° C. Furthermore, the softening temperature of the resin (resin including a polyimide resin) becomes about 450° C. (for example, in the case of (2)) or about 370° C. (for example, in the case of (3)), and this is included in the range of from 300° C. to 460° C. Furthermore, the softening temperature of the oxide becomes higher by 10° C. or more than the softening temperature of the resin.

Furthermore, in the case of such a combination of an oxide and a resin, it is preferable that the magnetic metal phase contains Fe and Co as the first element and contains Si and B as the additive element, and for example, an Fe₇₀Co₃₀B₂₅ (at %)−4 wt % Si composition is preferred. Incidentally, the crystallization temperature of the magnetic metal phase in the case of the Fe₇₀Co₃₀B₂₅ (at %)−4 wt % Si composition becomes about 555° C., and the softening temperatures of the oxide and the resin become lower by 50° C. or more than the crystallization temperature of the magnetic metal phase. When such a combination is satisfied, and the condition that the ratio of the oxide to the resin is from 0.1 to 10 as an area ratio is satisfied, it becomes possible to attain a state in which a stable oxide having a high softening temperature is fixed to the interface with the flaky magnetic metal particles, and it becomes possible to mitigate the strain to the flaky magnetic metal particles and to reduce coercivity. Furthermore, as the resin is disposed around the oxide and the flaky magnetic metal particles, it becomes possible to realize high strength by firmly hardening the magnetic metal phase. That is, it becomes possible to exhibit a specific effect of low coercivity (as well as low hysteresis loss and high magnetic permeability) and high strength, which is preferable.

Regarding the resin, it is preferable that the weight reduction percentage after heating for 3,000 hours at 180° C. in an air atmosphere is 5% or less, more preferably 3% or less, even more preferably 1% or less, and still more preferably 0.1% or less. Furthermore, the weight reduction percentage after heating for 200 hours at 220° C. in an air atmosphere is preferably 5% or less, more preferably 3% or less, even more preferably 1% or less, and still more preferably 0.1% or less. Furthermore, the weight reduction percentage after heating for 200 hours at 250° C. in an air atmosphere is preferably 5% or less, more preferably 3% or less, even more preferably 1% or less, and still more preferably 0.1% or less. An evaluation of these weight reduction percentages is carried out using a material in an unused state. An unused state refers to a state that can be used after shaping, and is a state in which the usable state has not been exposed to heat (for example, heat at a temperature of 40° C. or higher), chemicals, sunlight (ultraviolet radiation), or the like. The weight reduction percentage is calculated by the following formula from the masses obtained before and after heating: weight reduction percentage (%)=[mass (g) before heating−mass (g) after heating]/mass (g) before heating×100. It is also preferable that the strength after heating for 20,000 hours at 180° C. in an air atmosphere is a half or more of the strength before heating. It is more preferable that the strength after heating for 20,000 hours at 220° C. in an air atmosphere is a half or more of the strength before heating. Furthermore, it is preferable that the resin satisfies the division H defined by the Japanese Industrial Standards (JIS). Particularly, it is preferable that the resin satisfies the heat resistance condition of enduring a maximum temperature of 180° C. More preferably, it is preferable that the resin satisfies the division H defined by the Japanese National Railways Standards (JRE). Particularly, it is preferable that the resin satisfies the heat resistance condition of enduring a temperature increase of 180° C. with respect to the ambient temperature (standard: 25° C., maximum: 40° C.). Examples of a resin preferable for these conditions include a polysulfone, a polyether sulfone, polyphenylene sulfide, polyether ether ketone, an aromatic polyimide, an aromatic polyamide, an aromatic polyamideimide, polybenzoxazole, a fluororesin, a silicone resin, and a liquid crystal polymer. These resins have high intermolecular cohesive power, and therefore, the resins have high heat resistance, which is preferable. Among them, an aromatic polyimide and polybenzoxazole have higher heat resistance and are preferable, because the proportions occupied by rigid units in the molecules are high. Furthermore, it is preferable that the resin is a thermoplastic resin. The specifications about the weight reduction percentage upon heating, the specifications about strength, and the specifications about resin type as described above are respectively effective for increasing the heat resistance of the resin. Due to these, when a pressed powder material including a plurality of flaky magnetic metal particles and an intercalated phase (herein, a resin) is formed, the heat resistance of the pressed powder material is increased (thermal stability is increased), and the mechanical characteristics such as strength and toughness after being exposed to a high temperature (for example, 200° C. or 250° C. described above) or while being under a high temperature (for example, 200° C. or 250° C. described above), are likely to be enhanced, which is preferable. Also, since a large amount of the intercalated phase exists so as to surround the periphery of the flaky magnetic particles even after heating, the magnetic material has excellent oxidation resistance and does not easily undergo deterioration of the magnetic characteristics caused by oxidation of the flaky magnetic metal particles, which is preferable.

Furthermore, in regard to the pressed powder material, it is preferable that the weight reduction percentage after heating for 3,000 hours at 180° C. is 5% or less, more preferably 3% or less, even more preferably 1% or less, and still more preferably 0.1% or less. Furthermore, the pressed powder material is such that the weight reduction percentage after heating for 3,000 hours at 220° C. is preferably 5% or less, more preferably 3% or less, even more preferably 1% or less, and still more preferably 0.1% or less. Furthermore, the weight reduction percentage of the pressed powder material after heating for 200 hours at 250° C. in an air atmosphere is preferably 5% or less, more preferably 3% or less, even more preferably 1% or less, and still more preferably 0.1% or less. Meanwhile, the evaluation of the weight reduction percentage is similar to the case of the resin as described above. Furthermore, preferably, it is preferable that the strength of the pressed powder material after heating for 20,000 hours at 180° C. in an air atmosphere is a half or more of the strength before heating. It is more preferable that the strength of the pressed powder material after heating for 20,000 hours at 220° C. in an air atmosphere is a half or more of the strength before heating. Furthermore, it is preferable that the magnetic material satisfies the division H defined by the Japanese Industrial Standards (JIS). Particularly, it is preferable that the magnetic material satisfies the heat resistance condition of enduring a maximum temperature of 180° C. More preferably, it is preferable that the magnetic material satisfies the division H defined by the Japanese National Railways Standards (JRE). Particularly, it is preferable that the magnetic material satisfies the heat resistance condition of enduring a temperature increase of 180° C. with respect to the ambient temperature (standard: 25° C., maximum: 40° C.) The specifications about the weight reduction percentage upon heating, the specifications about strength, and the specifications about resin type as described above are respectively effective for increasing the heat resistance of the pressed powder material, and a material having high reliability can be realized. Since the heat resistance of the pressed powder material is increased (thermal stability is increased), and the mechanical characteristics such as strength and toughness after being exposed to a high temperature (for example, 200° C. or 250° C. described above) or while being under a high temperature (for example, 200° C. or 250° C. described above) are can be easily enhanced, which is preferable. Also, since a large amount of the intercalated phase exists so as to surround the periphery of the flaky magnetic particles even after heating, the magnetic material has excellent oxidation resistance and does not easily undergo deterioration of the magnetic characteristics caused by oxidation of the flaky magnetic metal particles, which is preferable.

Furthermore, it is preferable that the magnetic material includes a crystalline resin that does not have a glass transition point up to the thermal decomposition temperature. It is also preferable that the magnetic material includes a resin having a glass transition temperature of 180° C. or higher, and it is more preferable that the magnetic material includes a resin having a glass transition temperature of 220° C. or higher. It is even more preferable that the magnetic material includes a resin having a glass transition temperature of 250° C. or higher. Generally, the flaky magnetic metal particles have a larger average crystal grain size as the temperature of the heat treatment is higher. Therefore, in a case in which there is a need to make the average crystal grain size of the flaky magnetic metal particles small, it is preferable that the glass transition temperature of the resin to be used is not too high, and specifically, it is preferable that the glass transition temperature is 600° C. or lower. Furthermore, it is preferable that the crystalline resin that does not have a glass transition point up to the thermal decomposition temperature includes a resin having a glass transition temperature of 180° C. or higher, and it is more preferable that the crystalline resin includes a resin having a glass transition temperature of 220° C. or higher. Specifically, it is preferable that the crystalline resin includes a polyimide having a glass transition temperature of 180° C. or higher, it is more preferable that the crystalline resin includes a polyimide having a glass transition temperature of 220° C. or higher, and it is even more preferable that the crystalline resin includes a thermoplastic polyimide. As a result, fusion of the resin to the magnetic metal particles is likely to occur, and the resin can be suitably used particularly for powder-compacting molding. The thermoplastic polyimide is preferably a polyimide having an imide bond in the polymer chain of a thermoplastic aromatic polyimide, a thermoplastic aromatic polyamideimide, a thermoplastic aromatic polyetherimide, a thermoplastic aromatic polyesterimide, a thermoplastic aromatic polyimidesiloxane, or the like. Among them, when the glass transition temperature is 250° C. or higher, superior heat resistance is obtained, and thus it is preferable.

An aromatic polyimide and polybenzoxazole exhibit high heat resistance since an aromatic ring and a heterocyclic ring are directly bonded to each other and adopt a planar structure, and those planar structures are immobilized by π-π stacking. Thereby, the glass transition temperature can be increased, and thermal stability can be enhanced. Furthermore, the glass transition temperature can be easily adjusted to a desired glass transition point by appropriately introducing a curved unit such as an ether bond into the molecular structure, and thus it is preferable. Above all, when the benzene ring structure of a unit derived from an acid anhydride that constitutes the imide polymer is any one of a biphenyl structure, a triphenyl structure, and a tetraphenyl structure, it is preferable from the viewpoint of strength. Since the symmetric structure between imide groups, which affects heat resistance, is not damaged, and the orientation property also extends over a long distance, the material strength is also increased. An aromatic polyimide structure preferable for this is represented by the above-described Chemical Formula (1). In other words, it is preferable that the polyimide resin of the present embodiment includes a repeating unit represented by the above-described Chemical Formula (1).

When the characteristics (weight reduction percentage, resin type, glass transition temperature, molecular structure, and the like) of an intercalated phase (herein, a resin), which is a constituent component of the pressed powder material, are determined from the pressed powder material, only a portion of resin is cut out from the pressed powder material, and evaluation of various characteristics is carried out. In a case in which it cannot be determined by visual inspection whether the portion is formed from a resin or not, the resin and the magnetic metal particles are distinguished by using an elemental analysis based on EDX, or the like.

As the content of the resin contained in the entire pressed powder material is larger, the space between the polymer wetting (covering) a flaky magnetic metal particle and the polymer wetting (covering) an adjacent flaky magnetic metal particle can be filled with a polymer without difficulty, and thus mechanical characteristics such as strength are enhanced. Furthermore, the electrical resistivity is also increased, and the eddy current loss of the pressed powder material can be reduced, which is preferable. On the other hand, as the content of the resin is larger, the proportion of the flaky magnetic metal particles is decreased. Therefore, the saturation magnetization of the pressed powder material decreases, and the magnetic permeability is also decreased, which is not preferable. In order to realize a well-balanced material by comprehensively considering the mechanical characteristics such as strength, and characteristics such as electrical resistivity, eddy current loss, saturation magnetization, and magnetic permeability, it is preferable to adjust the content of the resin contained in the entire pressed powder material to 93 wt % or less, more preferably to 86 wt % or less, even more preferably to the range of from 2 wt % to 67 wt %, and still more preferably to the range of from 2 wt % to 43 wt %. Furthermore, the content of the flaky magnetic metal particles is preferably 7 wt % or more, more preferably 14 wt % or more, even more preferably from 33 wt % to 98 wt %, and still more preferably from 57 wt % to 98 wt %. The flaky magnetic metal particles are such that when the particle size decreases, the surface area increases, and the amount of the resin required is dramatically increased. Therefore, it is preferable that the flaky magnetic metal particles have an appropriately large particle size. As a result, the pressed powder material can be subjected to high saturation magnetization, the magnetic permeability can be made high, and this is advantageous for the size reduction and power output increase of a system.

In regard to the pressed powder material, it is preferable that the flat surfaces of the flaky magnetic metal particles described above are oriented in a layered form so as to be parallel to each other. The eddy current loss of the pressed powder material can be reduced thereby, and thus, it is preferable. Furthermore, since the demagnetizing field can be made small, the magnetic permeability of the pressed powder material can be made high, which is preferable. Also, since the ferromagnetic resonance frequency can be made high, the ferromagnetic resonance loss can be made small, which is preferable. Such a laminated structure is preferable because the magnetic domain structure is stabilized, and low magnetic loss can be realized. Here, as the angle formed by a face parallel to the flat surface of a flaky magnetic metal particle and a plane of the pressed powder material is closer to 0°, it is defined that the flaky magnetic metal particle is oriented. Specifically, the aforementioned angle is determined for a large number of flaky magnetic metal particles 10, that is, ten or more particles, and it is desirable that the average value is preferably from 0° to 45°, more preferably from 0° to 30°, and even more preferably from 0° to 10°.

The pressed powder material may have a laminated type structure composed of a magnetic layer containing the flaky magnetic metal particles, and an intermediate layer containing any of O, C, and N. In regard to the magnetic layer, it is preferable that the flaky magnetic metal particles are oriented (oriented such that the flat surfaces are made parallel to one another). Furthermore, it is preferable that the magnetic permeability of the intermediate layer is made lower than the magnetic permeability of the magnetic layer. Through these countermeasures, a laminated pseudo-thin film structure can be realized, and the magnetic permeability in the layer direction can be made high, which is preferable. In regard to such a structure, since the ferromagnetic resonance frequency can be made high, the ferromagnetic resonance loss can be made small, which is preferable. Furthermore, such a laminated structure is preferable because the magnetic domain structure is stabilized, and low magnetic loss can be realized. In order to further enhance these effects, it is more preferable to make the magnetic permeability of the intermediate layer lower than the magnetic permeability of the intercalated phase (intercalated phase within the magnetic layers). Thereby, the magnetic permeability in the layer direction can be made even higher in a laminated pseudo-thin film structure, and therefore, it is preferable. Also, since the ferromagnetic resonance frequency can be made even higher, the ferromagnetic resonance loss can be made small, which is preferable.

Thus, according to the present embodiment, a pressed powder material having excellent magnetic characteristics such as low magnetic loss and excellent mechanical characteristics such as high strength can be provided.

### Second Embodiment

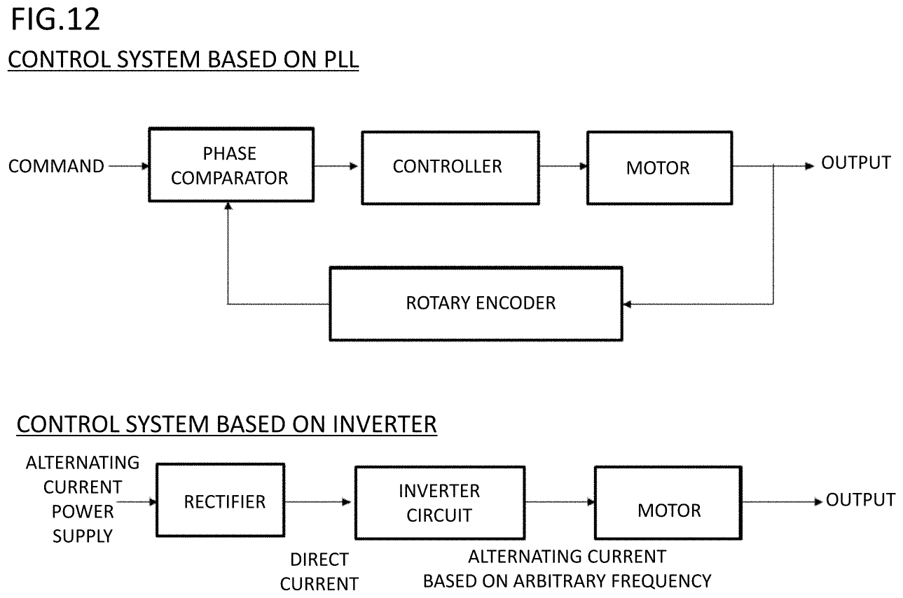

A system and a device apparatus of the present embodiment have the pressed powder material of the first embodiment. Therefore, any matters overlapping with the contents of the first embodiment will not be described repeatedly. Examples of the component parts of the pressed powder material included in these system and device apparatus include cores for rotating electric machines such as various motors and generators (for example, motors and generators), potential transformers, inductors, transformers, choke coils, and filters; and magnetic wedges for a rotating electric machine. FIG. 12 is a conceptual diagram of a motor system according to the second embodiment. A motor system is an example of the rotating electric machine system. A motor system is one system including a control system for controlling the rotational frequency or the electric power (output power) of a motor. Regarding the mode for controlling the rotational frequency of a motor, there are control methods that are based on control by a bridge servo circuit, proportional current control, voltage comparison control, frequency synchronization control, and phase locked loop (PLL) control. As an example, a control method based on PLL is illustrated in FIG. 12. A motor system that controls the rotational frequency of a motor based on PLL includes a motor; a rotary encoder that converts the amount of mechanical displacement of the rotation of the motor into electrical signals and detects the rotational frequency of the motor; a phase comparator that compares the rotational frequency of the motor given by a certain command, with the rotational frequency of the motor detected by the rotary encoder, and outputs the difference of those rotational frequencies; and a controller that controls the motor so as to make the difference of the rotational frequencies small. On the other hand, examples of the method for controlling the electric power of the motor include control methods that are based on pulse width modulation (PWM) control, pulse amplitude modulation (PAM) control, vector control, pulse control, bipolar drive, pedestal control, and resistance control. Other examples of the control method include control methods based on microstep drive control, multiphase drive control, inverter control, and switching control. As an example, a control method using an inverter is illustrated in FIG. 12. A motor system that controls the electric power of the motor using an inverter includes an alternating current power supply; a rectifier that converts the output of the alternating current power supply to a direct current; an inverter circuit that converts the direct current to an alternating current based on an arbitrary frequency; and a motor that is controlled by this alternating current.

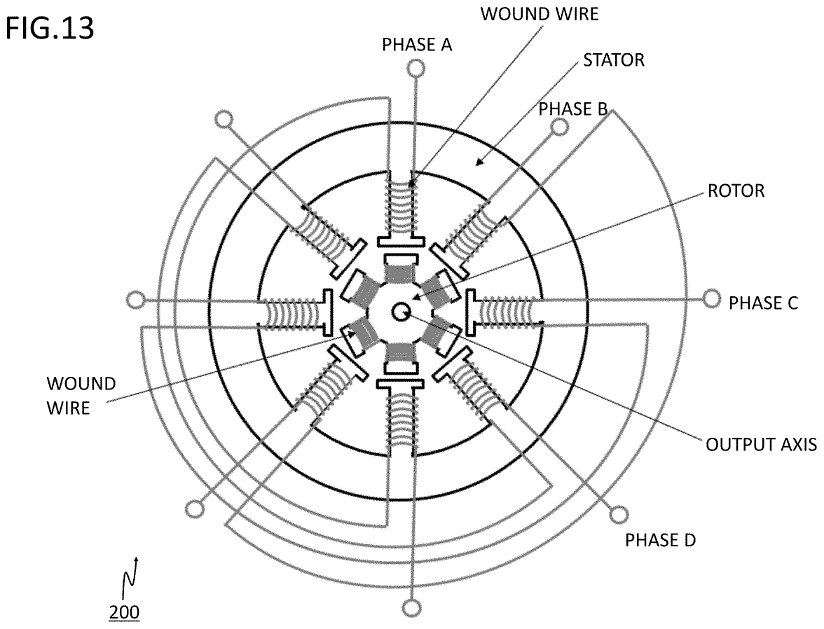

FIG. 13 illustrates a conceptual diagram of a motor according to the second embodiment. A motor 200 is an example of the rotating electric machine. In the motor 200, a first stator (magneto stator) and a second rotor (rotator) are disposed. The diagram illustrates an inner rotor type motor in which a rotor is disposed on the inner side of a stator; however, an outer rotor type motor in which the rotor is disposed on the outer side of the stator may also be used.

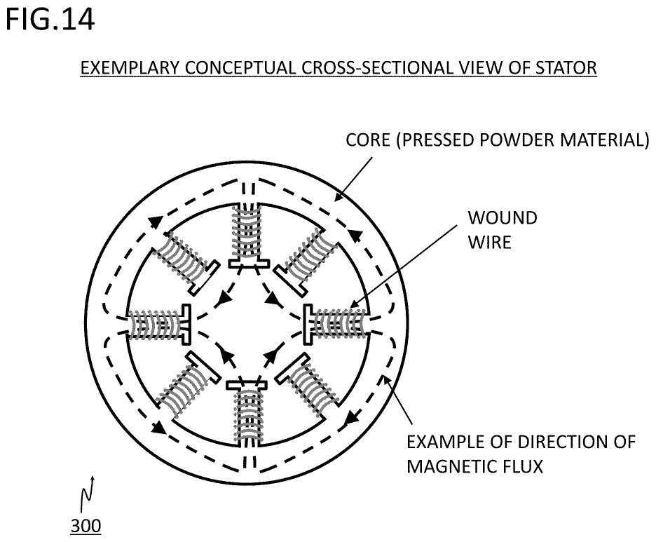

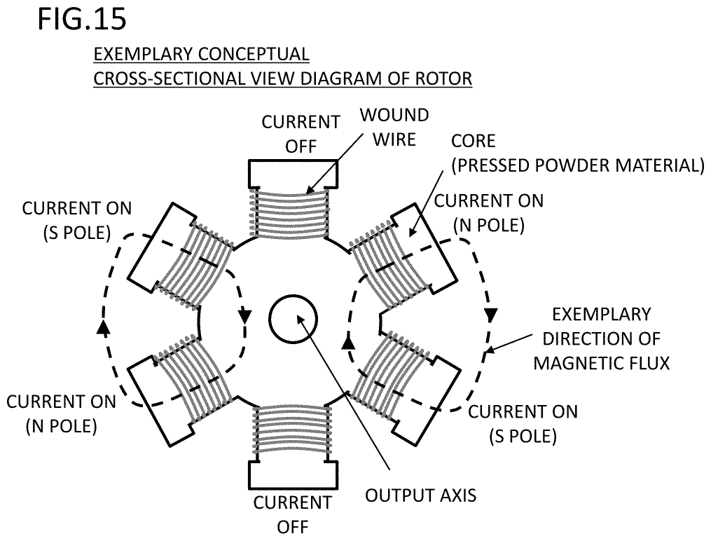

FIG. 14 is a conceptual diagram of a motor core (stator) according to the second embodiment. FIG. 15 is a conceptual diagram of a motor core (rotor) according to the second embodiment. Regarding the motor core 300 (core of a motor), the cores of a stator and a rotor correspond to the motor core. This will be described below. FIG. 14 is an exemplary conceptual cross-sectional diagram of a first stator. The first stator has a core and coils. The coils are wound around some of the protrusions of the core, which are provided on the inner side of the core. In this core, the pressed powder material of the first embodiment can be disposed. FIG. 15 is an exemplary conceptual cross-sectional diagram of the first rotor. The first rotor has a core and coils. The coils are wound around some of the protrusions of the core, which are provided on the outer side of the core. In this core, the pressed powder material of the second embodiment can be disposed.

FIG. 14 and FIG. 15 are intended only for illustrative purposes to describe examples of motors, and the applications of the pressed powder material are not limited to these. The pressed powder material can be applied to all kinds of motors as cores for making it easy to lead the magnetic flux.

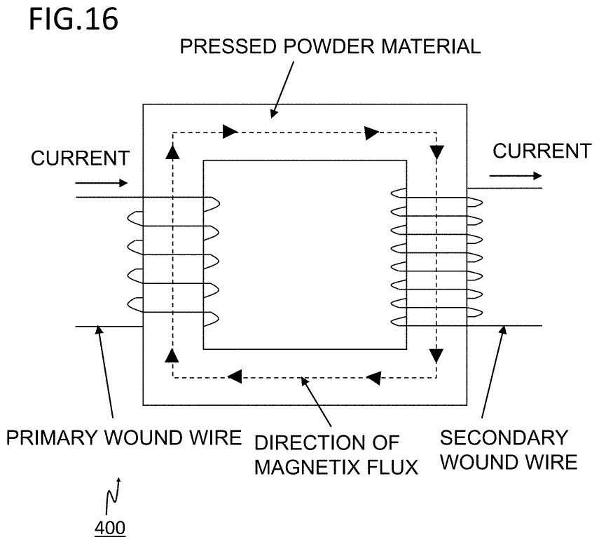

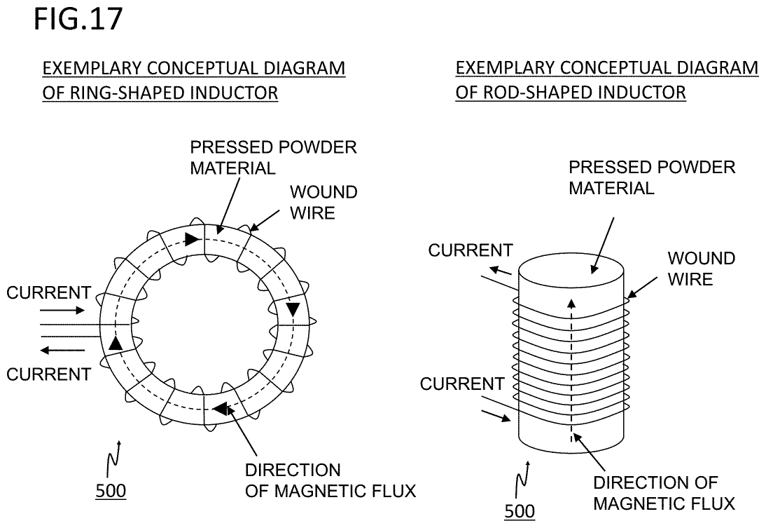

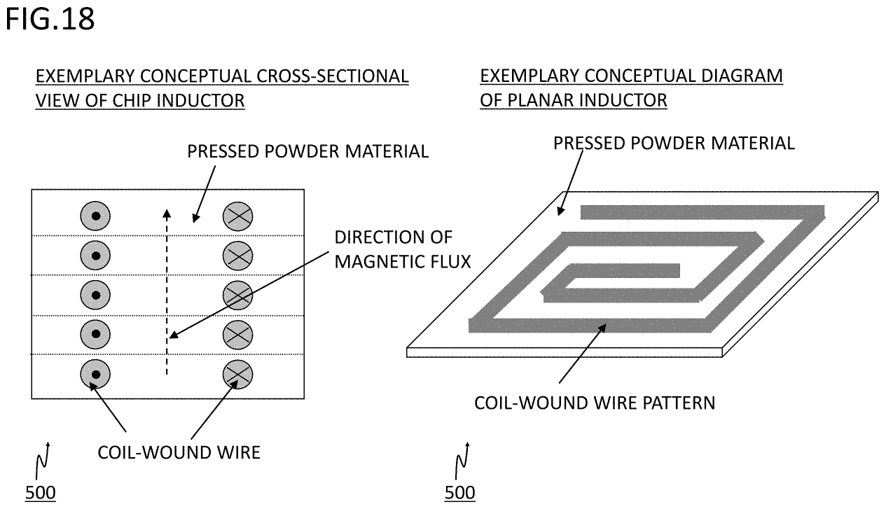

FIG. 16 is a conceptual diagram of a potential transformer or a transformer according to the second embodiment. FIG. 17 is a conceptual diagram of inductors (ring-shaped inductor and rod-shaped inductor) according to the second embodiment. FIG. 18 is a conceptual diagram of inductors (chip inductor and planar inductor) according to the second embodiment. These diagrams are also intended only for illustrative purposes. Also for the potential transformer or transformer 400 and the inductor 500, similarly to the motor core, the pressed powder material can be applied to all kinds of potential transformers or transformers and inductors in order to make it easy to lead the magnetic flux or to utilize high magnetic permeability.

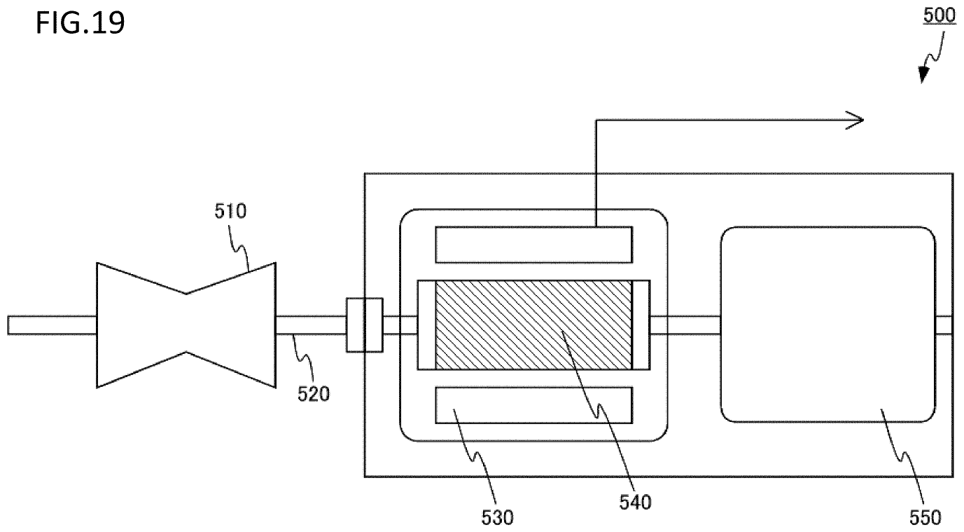

FIG. 19 is a conceptual diagram of a generator 500 according to the second embodiment. The generator 500 is an example of the rotating electric machine. The generator 500 includes either or both of a second stator (magneto stator) 530 that uses the pressed powder material of the first embodiment as the core; and a second rotor (rotator) 540 that uses the pressed powder material of the first embodiment as the core. In the diagram, the second rotor (rotator) 540 is disposed on the inner side of the second stator 530; however, the second rotor may also be disposed on the outer side of the second stator. The second rotor 540 is connected to a turbine 510 provided at an end of the generator 500 through a shaft 520. The turbine 510 is rotated by, for example, a fluid supplied from the outside, which is not illustrated in the diagram. Meanwhile, instead of the turbine that is rotated by a fluid, the shaft can also be rotated by transferring dynamic rotation of the regenerative energy of an automobile or the like. Various known configurations can be employed for the second stator 530 and the second rotor 540.

The shaft is in contact with a commutator (not illustrated in the diagram) that is disposed on the opposite side of the turbine with respect to the second rotor. The electromotive force generated by rotation of the second rotor is transmitted, as the electric power of the generator, after undergoing a voltage increase to the system voltage by means of an isolated phase bus that is not illustrated in the diagram, and a main transformer that is not illustrated in the diagram. Meanwhile, in the second rotor, an electrostatic charge is generated due to an axial current generated concomitantly with the static electricity from the turbine or with power generation. Therefore, the generator includes a brush intended for discharging the electrostatic charge of the second rotor.

The rotating electric machine of the present embodiment can be preferably used in railway vehicles. For example, the rotating electric machine can be preferably used in the motor 200 that drives a railway vehicle, or the generator 500 that generates electricity for driving a railway vehicle.

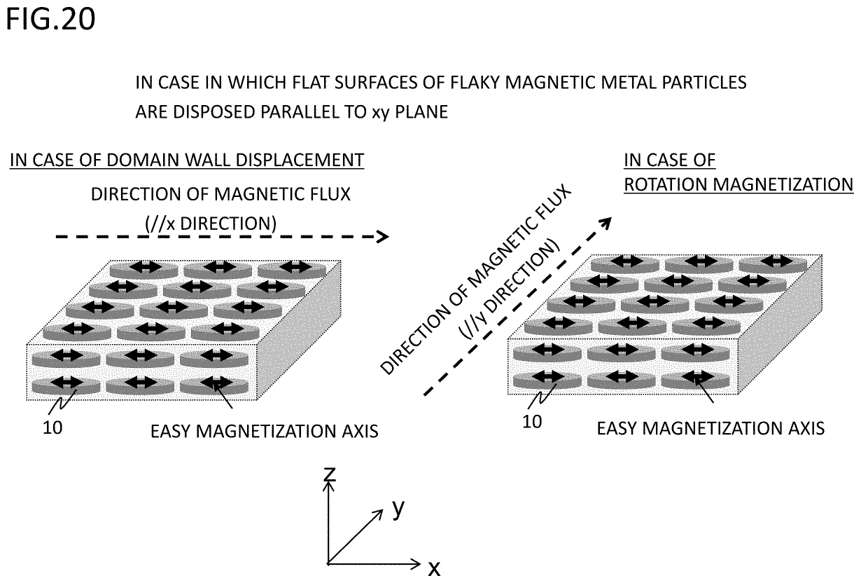

Furthermore, FIG. 20 is a conceptual diagram illustrating the relationship between the direction of the magnetic flux and the direction of disposition of a pressed powder material. First, for both of the domain wall displacement type and the rotation magnetization type, it is preferable that the flat surfaces of the flaky magnetic metal particles included in a pressed powder material are disposed in a direction in which the flat surfaces are parallel to one another as far as possible and are aligned in a layered form, with respect to the direction of the magnetic flux. This is because the eddy current loss can be reduced by making the cross-sectional area of the flaky magnetic metal particles that penetrate through the magnetic flux, as small as possible. Furthermore, in regard to the domain wall displacement type, it is preferable that the easy magnetization axis (direction of the arrow) in the flat surface of a flaky magnetic metal particle is disposed parallel to the direction of the magnetic flux. Thereby, the system can be used in a direction in which coercivity is further decreased, and therefore, the hysteresis loss can be reduced, which is preferable. Furthermore, the magnetic permeability is also made high, and it is preferable. In contrast, in regard to the rotation magnetization type, it is preferable that the easy magnetization axis (direction of the arrow) in the flat surface of a flaky magnetic metal particle is disposed perpendicularly to the direction of the magnetic flux. Thereby, the system can be used in a direction in which coercivity is further decreased, and therefore, the hysteresis loss can be reduced, which is preferable. That is, it is preferable to understand the magnetization characteristics of a pressed powder material, determine whether the magnetic material is of the domain wall displacement type or the rotation magnetization type (method for determination is as described above), and then dispose the magnetic material as illustrated in FIG. 20. In a case in which the direction of the magnetic flux is complicated, it may be difficult to dispose the magnetic material perfectly as illustrated in FIG. 20; however, it is preferable to dispose the magnetic material as illustrated in FIG. 20 as far as possible. It is desirable that the method for disposition described above is applied to all of the systems and device apparatuses of the present embodiment (for example, cores for rotating electric machines such as various motors and generators (for example, motors and generators), potential transformers, inductors, transformers, choke coils, and filters; and magnetic wedges for a rotating electric machine).

In order for a magnetic material to be applied to these systems and device apparatuses, the pressed powder material is allowed to be subjected to various kinds of processing. For example, in the case of a sintered body, the magnetic material is subjected to mechanical processing such as polishing or cutting; and in the case of a powder, the magnetic material is mixed with a resin such as an epoxy resin or polybutadiene. If necessary, the magnetic material is further subjected to a surface treatment. Also, if necessary, a coiling treatment is carried out.

When the system and device apparatus of the present embodiment are used, a motor system, a motor, a potential transformer, a transformer, an inductor, and a generator, all having excellent characteristics (high efficiency and low losses), can be realized.

### EXAMPLES

Hereinafter, embodiments will be described in more detail by comparing Examples 1 to 11 with Comparative Examples 1 to 6. For the pressed powder materials obtainable by Examples and Comparative Examples described below, a summary of the average thickness of the flaky magnetic metal particles, the average value of the ratio of the average length in the flat surface with respect to the thickness in each of the flaky magnetic metal particles, the softening temperature of the resin, the softening temperature of the oxide, the crystallization temperature of the magnetic metal phase, and the ratio of the oxide to the resin, is presented in Table 1.

### Example 1

First, a ribbon of Fe—Co—Si—B (Fe₇₀Co₃₀B₂₅ (at %)−4 wt % Si) is produced using a single roll quenching apparatus. Next, the ribbon thus obtained is subjected to a heat treatment at 300° C. in a H₂ atmosphere. Next, this ribbon is pulverized into a predetermined size using a mixer apparatus, and flaky magnetic metal particles are obtained. The crystallization temperature of the flaky magnetic metal particles thus obtained is 555° C. Subsequently, the flaky magnetic metal particles thus obtained are mixed with an oxide (Bi₂O₃—ZnO—B₂O₃: softening temperature 455° C.), the mixture is subjected to a heat treatment at the softening temperature and pressed, and thereby the oxide is properly fixed to the flaky magnetic metal particles. Subsequently, the mixture is lightly pulverized and mixed with a resin (polyimide resin: softening temperature 450° C.), molding in a magnetic field (the flaky particles are oriented) is performed, and hot press molding is performed using a hot press apparatus. Subsequently, the resultant is subjected to a heat treatment in a magnetic field, and thus a pressed powder material is obtained. In the heat treatment in a magnetic field, a magnetic field is applied in the direction of the easy magnetization axis, and a heat treatment is carried out. Incidentally, as described above, the intercalated phase includes an oxide and a resin, and the ratio of the oxide to the resin is 1. Furthermore, the softening temperature of the oxide was higher than the softening temperature of the resin, and the oxide was fixed to at least a portion of the flaky magnetic metal particles. The pressed powder material thus obtained had the difference in coercivity of 1% or more on the basis of direction within the plane.

### Example 2

The procedure is almost the same as in Example 1, except that boron oxide having a softening temperature of 460° C. is used as the oxide.

### Example 3

The procedure is almost the same as in Example 2, except that a polyimide resin having a softening temperature of 370° C. is used as the resin.

### Example 4

The procedure is almost the same as in Example 2, except that the composition of Fe—Co—Si—B is adjusted using the amount of B, and the crystallization temperature of the flaky magnetic metal particles is changed to 510° C.

### Example 5

The procedure is almost the same as in Example 2, except that the ratio of the oxide to the resin is adjusted to 0.1.

### Example 6

The procedure is almost the same as in Example 2, except that the ratio of the oxide to the resin is adjusted to 10.

### Example 7

With regard to Example 2, the ribbon is cut to an appropriate size using a mixer apparatus, subsequently the cut ribbon pieces are collected, pulverization and rolling are performed by means of a bead mill using a ZrO₂ balls and a ZrO₂ container in an Ar atmosphere at about 1,000 rpm to make the ribbon pieces into a flaky powder, and thus flaky magnetic metal particles obtained. The procedure is almost the same as in Example 2, except that by repeating the above-described operation of pulverization and rolling the operation of heat treatment, the average thickness of the flaky magnetic metal particles is adjusted to 10 nm, and the average value of the ratio of the average length in the flat surface with respect to thickness is adjusted to 200.

### Example 8

The procedure is almost the same as in Example 7, except that the average thickness of the flaky magnetic metal particles is adjusted to 1 μm, and the average value of the ratio of the average length in the flat surface with respect to thickness is adjusted to 100.

### Example 9

The procedure is almost the same as in Example 7, except that the average thickness of the flaky magnetic metal particles is 100 μm, and the average value of the ratio of the average length in the flat surface with respect to thickness is 5.

### Example 10

The procedure is almost the same as in Example 7, except that the average thickness of the flaky magnetic metal particles is 10 nm, and the average value of the ratio of the average length in the flat surface with respect to thickness is 1,000.

### Example 11

The procedure is almost the same as in Example 7, except that the average thickness of the flaky magnetic metal particles is 10 nm, and the average value of the ratio of the average length in the flat surface with respect to thickness is 10,000.

### Comparative Example 1

The procedure is almost the same as in Example 2, except that an oxide is not used but only a resin is used (the intercalated phase is composed only of a polyimide resin).

### Comparative Example 2

The procedure is almost the same as in Example 2, except that a resin is not used but only an oxide is used (the intercalated phase is composed only of an oxide).

### Comparative Example 3

The procedure is almost the same as in Example 2, except that Bi₂O₃—ZnO—B₂O₃ having a softening temperature of 440° C. is used as the oxide.

### Comparative Example 4

The procedure is almost the same as in Example 2, except that the ratio of the oxide to the resin is adjusted to 0.08.

### Comparative Example 5

The procedure is almost the same as in Example 2, except that the ratio of the oxide to the resin is adjusted to 12.

### Comparative Example 6

The procedure is almost the same as in Example 2, except that the composition of Fe—Co—Si—B is adjusted using the amount of B, and the crystallization temperature of the flaky magnetic metal particles is adjusted to 500° C.

Next, with regard to the materials for evaluation of Examples 1 to 11 and Comparative Examples 1 to 6, the magnetic permeability, tan δ, core loss, the proportion of change over time in the real part of magnetic permeability (μ′), and strength ratio are evaluated. For the magnetic permeability and tan δ, values at 100 Hz are employed. For the core loss, the proportion of change over time in the real part of magnetic permeability (μ′), and strength ratio, evaluation is carried out by the following methods. The evaluation results are presented in Table 2.

(1) Core loss: The core loss under the operation conditions of 100 Hz and 1 T is measured using a B-H analyzer. In a case in which measurement cannot be directly performed under the conditions of 100 Hz and 1 T, the dependency on frequency and the dependency on magnetic flux density of the core loss are measured, and the core loss at 100 Hz and 1 T is estimated from those data (then, this estimated value is employed).

(2) Proportion of change over time in real part of magnetic permeability μ′: The real part of magnetic permeability μ′ of a ring-shaped sample is measured at 100 Hz using an impedance analyzer. Subsequently, the sample for evaluation is heated at a temperature of 100° C. for 100 hours in an air atmosphere, the real part of magnetic permeability μ′ is measured again, and the change over time (real part of magnetic permeability μ′ after standing for 100 hours/real part of magnetic permeability μ′ before standing) is determined.

(3) Strength ratio: The flexural strength at room temperature of a sample for evaluation is measured, and this is expressed as the ratio with the flexural strength at room temperature of the sample of Comparative Example 1 (=flexural strength at room temperature of sample for evaluation/flexural strength at room temperature of sample of Comparative Example 1).

TABLE 1

| | Flaky magnetic metal particles | | | | Crystallization | | |
|---|---|---|---|---|---|---|---|
| | | Average value of | Softening | Softening | temperature of | Ratio of | |
| | Average | ratio of average | temperature | temperature | magnetic metal | oxide to | |
| | thickness | length to thickness | of resin | of oxide | phase | resin | Remarks |
| Example 1 | 10 μm | 20 | 450° C. | 455° C. | 555° C. | 1 | — |
| Example 2 | 10 μm | 20 | 450° C. | 460° C. | 555° C. | 1 | Oxide is boron oxide |
| Example 3 | 10 μm | 20 | 370° C. | 460° C. | 555° C. | 1 | |
| Example 4 | 10 μm | 20 | 450° C. | 460° C. | 510° C. | 1 | |
| Example 5 | 10 μm | 20 | 450° C. | 460° C. | 555° C. | 0.1 | |
| Example 6 | 10 μm | 20 | 450° C. | 460° C. | 555° C. | 10 | |
| Example 7 | 10 nm | 200 | 450° C. | 460° C. | 555° C. | 1 | Size of flaky magnetic metal |
| Example 8 | 1 μm | 100 | 450° C. | 460° C. | 555° C. | 1 | particles is changed on |
| Example 9 | 100 μm | 5 | 450° C. | 460° C. | 555° C. | 1 | basis of Example 2 |
| Example 10 | 10 nm | 1000 | 450° C. | 460° C. | 555° C. | 1 | |
| Example 11 | 10 nm | 10000 | 450° C. | 460° C. | 555° C. | 1 | |
| Comparative | 10 μm | 20 | 450° C. | — | 555° C. | — | Resin only |
| Example 1 | | | | | | | |
| Comparative | 10 μm | 20 | — | 460° C. | 555° C. | — | Oxide only |
| Example 2 | | | | | | | |
| Comparative | 10 μm | 20 | 450° C. | 440° C. | 555° C. | 1 | Softening temperature of |
| Example 3 | | | | | | | resin > Softening |
| | | | | | | | temperature of oxide |
| Comparative | 10 μm | 20 | 450° C. | 460° C. | 555° C. | 0.08 | Ratio of oxide to resin is |
| Example 4 | | | | | | | deviated from definition |
| Comparative | 10 μm | 20 | 450° C. | 460° C. | 555° C. | 12 | |
| Example 5 | | | | | | | |
| Comparative | 10 μm | 20 | 450° C. | 460° C. | 500° C. | 1 | Crystallization temperature |
| Example 6 | | | | | | | of magnetic metal phase is |
| | | | | | | | deviated from definition |

TABLE 2

| | | | Core loss | Proportion of | |
|---|---|---|---|---|---|
| | μ′ | tan δ(%) | (kW/m³) | change over | Strength |
| | (100 Hz) | (100 Hz) | 100 Hz, 1 T | time in μ′ (%) | ratio |
| Example 1 | 170 | ≈0 | 32 | 92 | 0.97 |
| Example 2 | 180 | ≈0 | 30 | 93 | 0.97 |
| Example 3 | 200 | ≈0 | 25 | 94 | 0.99 |
| Example 4 | 160 | ≈0 | 35 | 92 | 0.96 |
| Example 5 | 175 | ≈0 | 32 | 92 | 0.97 |
| Example 6 | 180 | ≈0 | 31 | 93 | 0.97 |
| Example 7 | 160 | ≈0 | 30 | 92 | 0.96 |
| Example 8 | 165 | ≈0 | 31 | 93 | 0.97 |
| Example 9 | 170 | ≈0 | 34 | 93 | 0.97 |
| Example 10 | 160 | ≈0 | 30 | 93 | 0.97 |
| Example 11 | 165 | ≈0 | 31 | 93 | 0.97 |
| Comparative | 100 | ≈0 | 70 | 88 | — |
| Example 1 | | | | | |
| Comparative | 150 | ≈0 | 40 | 89 | 0.2 |
| Example 2 | | | | | |
| Comparative | 140 | ≈0 | 45 | 89 | 0.3 |
| Example 3 | | | | | |
| Comparative | 130 | ≈0 | 60 | 89 | 0.8 |
| Example 4 | | | | | |
| Comparative | 140 | ≈0 | 50 | 89 | 0.7 |
| Example 5 | | | | | |
| Comparative | 150 | ≈0 | 50 | 88 | 0.8 |
| Example 6 | | | | | |

As is obvious from Table 1, the flaky magnetic metal particles of the pressed powder materials according to Examples 1 to 11 have an average thickness of from 10 nm to 100 μm, and the average value of the ratio of the average length in the flat surface with respect to thickness is from 5 to 10,000. Furthermore, the flaky magnetic metal particles have the difference in coercivity on the basis of direction within the plane of the pressed powder material. Also, the intercalated phase includes an oxide and a resin, the softening temperature of the oxide is higher than the softening temperature of the resin, and the oxide is fixed to at least a portion of the flaky magnetic metal particles. Furthermore, the softening temperature of the oxide is lower by 50° C. or more than the crystallization temperature of the magnetic metal phase. Furthermore, the ratio of the oxide to the resin is from 0.1 to 10 as an area ratio. Example 2 is an embodiment resulting from changing the oxide of Example 1 to boron oxide. Example 3 is an embodiment having the softening temperature of the resin included in the range of from 300° C. to 400° C. In contrast, Comparative Example 1 includes only a resin (not including an oxide) as the intercalated phase, and Comparative Example 2 includes only an oxide (not including a resin) as the intercalated phase. Furthermore, Comparative Example 3 includes a resin and an oxide as the intercalated phase; however, the softening temperature of the resin is higher than the softening temperature of the oxide. Comparative Examples 4 and 5 each include a resin and an oxide as the intercalated phase, and the softening temperature of the oxide is higher than the softening temperature of the resin; however, the ratio of the oxide to the resin is deviated from the range of from 0.1 to 10 as an area ratio. Comparative Example 6 is deviated from the condition that “the softening temperature of the oxide is lower by 50° C. or more than the crystallization temperature of the magnetic metal phase”.

As is obvious from Table 2, it is understood that the pressed powder materials of Examples 1 to 11 are excellent in terms of the magnetic permeability, core loss, the proportion of change over time in μ′, and strength ratio, as compared to the pressed powder materials of Comparative Examples 1 to 6. That is, it is understood that the pressed powder materials are excellent in terms of the magnetic characteristics, thermal stability, and mechanical characteristics (strength). Comparative Example 1 includes only a resin as the intercalated phase and has high strength; however, the magnetic characteristics are low (low magnetic permeability, high core loss, and a low proportion of change over time in the magnetic permeability). Furthermore, Comparative Example 2 includes only an oxide as the intercalated phase, has low magnetic characteristics (low magnetic permeability, high core loss, and a low proportion of change over time in the magnetic permeability), and has fairly low strength. Comparative Example 3 includes a resin and an oxide as the intercalated phase; however, the softening temperature of the resin is higher than the softening temperature of the oxide, and the characteristics are not satisfactory without much difference from the characteristics of Comparative Example 2. Comparative Examples 4 and 5 each include a resin and an oxide as the intercalated phase, and the softening temperature of the oxide is higher than the softening temperature of the resin; however, the ratio of the oxide to the resin is deviated from the range of from 0.1 to 10 as an area ratio, while the magnetic characteristics and strength are all low. Comparative Example 6 is deviated from the condition that “the softening temperature of the oxide is lower by 50° C. or more than the crystallization temperature of the magnetic metal phase”, and the magnetic characteristics and strength are all low. In contrast, the pressed powder materials of Examples 1 to 11 have specifically excellent characteristics as compared to the pressed powder materials of Comparative Examples 1 to 6. This specific effect is brought by the fact that the pressed powder materials include both an oxide and a resin as the intercalated phase, the softening temperature of the oxide is higher than the softening temperature of the resin, the oxide is fixed to at least a portion of the flaky magnetic metal particles, the softening temperature of the oxide is lower by 50° C. or more than the crystallization temperature of the magnetic metal phase, and the ratio of the oxide to the resin is from 0.1 to 10 as an area ratio. Particularly, by selecting a stable oxide having a high softening temperature and attaining a state in which the oxide is fixed to the interface with the flaky magnetic metal particles, the strain to the flaky magnetic metal particles is mitigated, coercivity is reduced (magnetic permeability is enhanced, and the hysteresis loss, that is, core loss, is reduced), and as the resin is disposed around the oxide and the flaky magnetic metal particles, it is possible to realize high strength by firmly hardening the resin. Furthermore, it is known that Example 2 is an embodiment resulting from changing the oxide of Example 1 to boron oxide; however, thereby the magnetic permeability, core loss, the proportion of change over time in μ′, and strength ratio are enhanced as compared to Example 1. Furthermore, it is understood that Example 3 is an embodiment in which the softening temperature of the resin is included in the range of from 300° C. to 400° C.; however, thereby, the magnetic permeability, core loss, the proportion of change over time in μ′, and strength ratio are further enhanced as compared to Example 2. Meanwhile, since the materials of Examples are pressed powder materials, the materials can be applied to complicated shapes.

Several embodiments and Examples of the present embodiments have been described; however, these embodiments and Examples have been suggested for an illustrative purpose and are not intended to limit the scope of embodiments. These novel embodiments can be carried out in other various forms, and to the extent that the gist of the embodiments is maintained, various omissions, substitutions, and modifications can be carried out. These embodiments and modifications thereof are included in the scope or gist of embodiments and are also included in a scope equivalent to the embodiments described in the scope of the claims.

While certain embodiments have been described, these embodiments have been presented by way of example only, and are not intended to limit the scope of the inventions. Indeed, the pressed powder material and the rotating electric machine described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions. What is claimed is:

1. A pressed powder material comprising a plurality of flaky magnetic metal particles and an intercalated phase,
each of the flaky magnetic metal particles having a flat surface; and a magnetic metal phase containing at least one first element selected from the group consisting of iron (Fe), cobalt (Co), and nickel (Ni), the flaky magnetic metal particles having an average thickness of from 10 nm to 100 μm and an average value of the ratio of the average length in the flat surface with respect to the thickness of from 5 to 10,000,
the intercalated phase existing between the flaky magnetic metal particles and containing at least one second element selected from the group consisting of oxygen (O), carbon (C), nitrogen (N), and fluorine (F),
wherein in the pressed powder material, the flat surface is oriented in parallel to a plane of the pressed powder material and has the difference in coercivity on the basis of direction within the plane,
the intercalated phase includes an oxide and a resin, the softening temperature of the oxide is higher than the softening temperature of the resin, and the oxide is fixed to at least a portion of the flaky magnetic metal particles.

2. The pressed powder material according to claim 1, wherein the softening temperature of the oxide is higher by 10° C. or more than the softening temperature of the resin.

3. The pressed powder material according to claim 1, wherein the softening temperature of the resin is from 300° C. to 400° C.

4. The pressed powder material according to claim 1, wherein the softening temperature of the oxide is lower by 50° C. or more than the crystallization temperature of the magnetic metal phase.

5. The pressed powder material according to claim 1, wherein the ratio of the oxide to the resin is from 0.1 to 10 as an area ratio.

6. The pressed powder material according to claim 1, wherein the magnetic metal phase contains at least one additive element selected from the group consisting of B, Si, Al, C, Ti, Zr, Hf, Nb, Ta, Mo, Cr, Cu, W, P, N, Ga, and Y.

7. The pressed powder material according to claim 6, wherein the magnetic metal phase contains Fe and Co as the first element and contains Si and B as the additive element.

8. The pressed powder material according to claim 1, wherein the oxide includes boron oxide.

9. The pressed powder material according to claim 1, wherein the resin includes a polyimide resin.

10. The pressed powder material according to claim 9, wherein the polyimide resin includes a repeating unit represented by the following Chemical Formula (1):

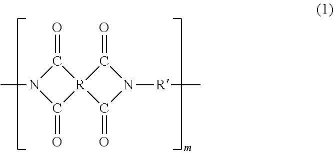

11. The pressed powder material according to claim 1, wherein the average crystal grain size of the magnetic metal phase is 10 nm or less.

12. The pressed powder material according to claim 1, wherein at least a portion of the surface of the flaky magnetic metal particles is covered with a coating layer having a thickness of from 0.1 nm to 1 μm and containing at least one second element selected from the group consisting of oxygen (0), carbon (C), nitrogen (N), and fluorine (F).

13. The pressed powder material according to claim 1, wherein the proportion of the difference in coercivity on the basis of direction within the plane of the pressed powder material is 1% or more.

14. A rotating electric machine comprising the pressed powder material according to claim 1.
